(19) United States
(12) Patent Application Publication
(10) Pub. No.: US 2017/0042162 A1
(43) Pub. Date: Feb. 16, 2017

(54) COMPOSITIONS, METHODS OF MAKING A COMPOSITION, AND METHODS OF USE

(71) Applicant: UNIVERSITY OF CENTRAL FLORIDA RESEARCH FOUNDATION, INC., Orlando, FL (US)

(72) Inventors: Swadeshmukul Santra, Oviedo, FL (US); Mikaeel Young, Oviedo, FL (US)

(73) Assignee: UNIVERSITY OF CENTRAL FLORIDA RESEARCH FOUNDATION, INC., Orlando, FL (US)

(21) Appl. No.: 15/306,907

(22) PCT Filed: Apr. 27, 2015
(86) PCT No.: PCT/US2015/027726

§ 371 Date: Oct. 26, 2016

Related U.S. Application Data
(60) Provisional application No. 61/984,939, filed on Apr. 28, 2014.

(51) Int. Cl. A01N 59/20; A01N 25/10

(52) U.S. Cl. CPC A01N 59/20; A01N 25/10

(57) ABSTRACT

Embodiments of the present disclosure, in one aspect, relate to compositions including a copper/silica nanocomposite and a polymer, methods of making a composition, methods of using a composition, and the like. An embodiment of the present disclosure provides for a composition, among others, that includes: a copper/silica nanocomposite having a silica gel matrix that includes copper from one or more of copper nanopartides and copper ions, and a polymer selected from the group consisting of: polyvinylpyrrolidone, poryacrylamide, polylactic acid, polyglycolic acid, starch, a quaternary ammonium compound, and a combination thereof.

### CLAIM OF PRIORITY TO RELATED APPLICATION

This application claims priority to co-pending U.S. provisional application entitled “COMPOSITIONS, METHODS OF MAKING A COMPOSITION, AND METHODS OF USE” having Ser. No. 61/984,939, and filed on Apr. 28, 2014, which is entirely incorporated herein by reference.

This application is a continuation in-part application of U.S. Utility Application entitled “COMPOSITIONS, METHODS OF MAKING A COMPOSITION, AND METHODS OF USE” having Ser. No. 14/049,732, and filed Oct. 9, 2013, which is entirely incorporated herein by reference.

### BACKGROUND

The globalization of business, travel and communication brings increased attention to worldwide exchanges between communities and countries, including the potential globalization of the bacterial and pathogenic ecosystem. Bactericides and fungicides have been developed to control diseases in man, animal and plants, and must evolve to remain effective as more and more antibiotic, pesticide and insecticide resistant bacteria and fungi appear around the globe.

Bacterial resistance to antimicrobial agents has also emerged, throughout the world, as one of the major threats to both man and the agrarian lifestyle. Resistance to antibacterial and antifungal agents has emerged as an agricultural issue that requires attention and 20 improvements in the treatment materials in use today.

For example, focusing on plants, there are over 300,000 diseases that afflict plants worldwide, resulting in billions of dollars of annual crop losses. The antibacterial/antifungal formulations in existence today could be improved and made more effective.

### SUMMARY

Embodiments of the present disclosure, in one aspect, relate to compositions including a copper/silica nanocomposite and a polymer, methods of making a composition, methods of using a composition, and the like.

An embodiment of the present disclosure provides for a composition, among others, that includes: a copper/silica nanocomposite having a silica gel matrix that includes copper from one or more of copper nanoparticles and copper ions, and a polymer selected from the group consisting of: polyvinylpyrrolidone, polyacrylamide, polylactic acid, polyglycolic acid, starch, a quaternary ammonium compound, and a combination thereof.

An embodiment of the present disclosure provides for a method of making a composition, among others, that includes: mixing a silica precursor compound, a copper precursor compound, and water; adjusting the pH to less than about 7 and holding for about 12 to 36 hours; forming a copper/silica nanocomposite having a silica gel matrix that includes copper from one or more of copper nanoparticles and copper ions; mixing a polymer with the mixture while having an acidic pH for about 12 to 36 hours, wherein the polymer is selected from the group consisting of: a polymer selected from the group consisting of: polyvinylpyrrolidone, polyacrylamide, polylactic acid, polyglycolic acid, starch, a quaternary ammonium compound, and a combination thereof; raising the pH to about 4 to 10; and forming the composition.

An embodiment of the present disclosure provides for a method, among others, that includes: disposing a composition on a surface, wherein the composition has a copper/silica nanocomposite having a silica gel matrix that includes copper from one or more of copper nanoparticles and copper ions, and a polymer selected from the group consisting of: a polymer selected from the group consisting of: polyvinylpyrrolidone, polyacrylamide, polylactic acid, polyglycolic acid, starch, a quaternary ammonium compound, and a combination thereof; and killing a substantial portion of a microorganism or inhibiting or substantially inhibiting the growth of the microorganisms on the surface of a structure or that come into contact with the surface of the structure.

Other composition, methods, features, and advantages will be, or become, apparent to one with skill in the art upon examination of the following drawings and detailed description. It is intended that all such additional structures, systems, methods, features, and advantages be included within this description, be within the scope of the present disclosure, and be protected by the accompanying claims.

### BRIEF DESCRIPTION OF THE DRAWINGS

Many aspects of this disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 illustrates spherical clusters of material within SG0023 seen in SEM.

FIG. 2 illustrates EDS of elements in sample from FIG. 1 within SG0023. Cu and Si confirmed.

FIG. 3 illustrates spherical clusters of material within SG0023 seen in SEM.

FIG. 4 illustrates EDS of elements in sample from FIG. 3 within SG0023. Cu and Si confirmed.

FIG. 5 illustrates spherical clusters of material within SG0023 seen in SEM.

FIG. 6 illustrates EDS of SG0023 sample seen in HRTEM. Cu and Si confirmed.

FIG. 7 illustrates high-resolution, low magnification image of SG0023 showing areas of dark contrast indicating electron rich material.

FIG. 8 illustrates SAED image of SG0023 confirming crystalline nature.

FIG. 9 illustrates high-resolution, high magnification image of SG0023 showing areas of dark contrast indicating electron rich material.

FIG. 10 illustrates high-resolution, high magnification image of SG0023 showing areas of dark contrast indicating electron rich material. Cu Crystallites can be seen with sizes between 4-8 nm. Lattice spacing of crystallites determined as 2.76 Å, 2.27 Å, 3.03 Å, 1.78 Å and 2.54 Å.

FIG. 11 illustrates high-resolution, high magnification image of SG0023 showing areas of dark contrast indicating electron rich material. Cu Crystallites can be seen with sizes between 4-8 nm. Lattice spacing of crystallites determined as 2.76 Å, 2.27 Å, 3.03 Å, 1.78 Å and 2.54 Å.

FIG. 12 illustrates EDS of SG0024 sample seen in HRTEM. Cu and Si confirmed.

FIG. 13 illustrates high-resolution, low magnification image of SG0024 showing areas of dark contrast indicating electron rich material.

FIG. 14 illustrates high-resolution, low magnification image of SG0024 showing areas of dark contrast indicating electron rich material.

FIG. 15 illustrates SAED image of SG0024 confirming crystalline nature.

FIG. 16 illustrates high-resolution, high magnification image of SG0024 showing areas of dark contrast indicating electron rich material. Cu Crystallites can be seen with sizes between 4-8 nm. Lattice spacing of crystallites determined as 2.75 Å, 2.45 Å and 2.26 Å.

FIG. 17 illustrates high-resolution, high magnification image of SG0024 showing areas of dark contrast indicating electron rich material. Cu Crystallites can be seen with sizes between 4-8 nm. Lattice spacing of crystallites determined as 2.75 Å, 2.45 Å and 2.26 Å.

FIG. 18 illustrates spherical clusters of material within SG0024 seen in SEM.

FIG. 19 illustrates EDS of elements in sample from FIG. 18 within SG0024. Cu and Si confirmed.

FIG. 20 illustrates clusters of material within SG0024 seen in SEM.

FIG. 21 illustrates EDS of elements in sample from FIG. 20 within SG0024. Cu and Si confirmed.

FIG. 22 is a table that illustrates the phytotoxicity studies of SG0001, SG0005, SG0015, SG0017 and SG0018 at Cu concentrations of 450, 700 and 900 ppm. (−) No damage, (+) Moderate damage, (++) Heavy damage.

FIG. 23 is a table that illustrates the phytotoxicity studies of SG0020, SG0021 and SG0022 at Cu concentrations of 300, 500 and 700 ppm. (−) No damage, (+) Moderate damage, (++) Heavy damage.

FIG. 24 is a table that illustrates the phytotoxicity studies of SG0022M, SG0023 and SG0024 at Cu concentrations of 500, 700 and 900 ppm. (−) No damage, (+) Moderate damage, (++) Heavy damage.

FIG. 25 is a study that illustrates the minimum inhibitory concentration (MIC) of SG nanoformulations and Kocide 3000 against E. coli expressed in Cu concentration ((μg/mL).

FIG. 26 is a graphs that illustrates the growth inhibition of E. coli in the presence of SG0001, SG0005, SG0015, SG0017, SG0018 and Kocide 3000.

FIG. 27 is a graph that illustrates the growth inhibition of E. coli in the presence of SG0020, SG0021, SG0022 and Kocide 3000.

FIG. 28 is a graph that illustrates the growth inhibition of E. coli in the presence of SG0022M, SG0023, SG0024 and Kocide 3000.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features that may be readily separated from or combined with the features of any of the other several embodiments without departing from the scope or spirit of the present disclosure. Any recited method can be carried out in the order of events recited or in any other order that is logically possible.

Embodiments of the present disclosure will employ, unless otherwise indicated, techniques of chemistry, polymer chemistry, biology, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is in atmospheres. Standard temperature and pressure are defined as 25° C. and 1 atmosphere.

Before the embodiments of the present disclosure are described in detail, it is to be understood that, unless otherwise indicated, the present disclosure is not limited to particular materials, reagents, reaction materials, manufacturing processes, or the like, as such can vary. It is also to be understood that the terminology used herein is for purposes of describing particular embodiments only, and is not intended to be limiting. It is also possible in the present disclosure that steps can be executed in different sequence where this is logically possible.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### DEFINITIONS

The term “antimicrobial characteristic” refers to the ability to kill and/or inhibit the growth of microorganisms. A substance having an antimicrobial characteristic may be harmful to microorganisms (e.g., bacteria, fungi, protozoans, algae, and the like). A substance having an antimicrobial characteristic can kill the microorganism and/or prevent or substantially prevent the growth or reproduction of the microorganism.

The term “antibacterial characteristic” refers to the ability to kill and/or inhibit the growth of bacteria. A substance having an antibacterial characteristic may be harmful to bacteria. A substance having an antibacterial characteristic can kill the bacteria and/or prevent or substantially prevent the replication or reproduction of the bacteria.

“Uniform plant surface coverage” refers to a uniform and complete (e.g., about 100%) wet surface due to spray application of embodiments of the present disclosure. In other words, spray application causes embodiments of the present disclosure to spread throughout the plant surface.

“Substantial uniform plant surface coverage” refers to about 70%, about 80%, about 90%, or more uniform plant surface coverage.

“Substantially covering” refers to covering about 70%, about 80%, about 90%, or more, of the leaves and branches of a plant.

“Plant” refers to trees, plants, shrubs, flowers, and the like as well as portions of the plant such as twigs, leaves, stems, branches, fruit, flowers, and the like. In a particular embodiment, the term plant includes a fruit tree such as a citrus tree (e.g., orange tree, lemon tree, lime tree, and the like).

The terms “alk” or “alkyl” refer to straight or branched chain hydrocarbon groups having 1 to 12 carbon atoms, preferably 1 to 8 carbon atoms, such as methyl, ethyl, n-propyl, i-propyl, n-butyl, i-butyl, t-butyl, pentyl, hexyl, heptyl, n-octyl, dodecyl, octadecyl, amyl, 2-ethylhexyl, and the like. Alkyl can include alkyl, dialkyl, trialkyl, and the like.

As used herein, “treat”, “treatment”, “treating”, and the like refer to acting upon a disease or condition with a composition of the present disclosure to affect the disease or condition by improving or altering it. In addition, “treatment” includes completely or partially preventing (e.g., about 70% or more, about 80% or more, about 90% or more, about 95% or more, or about 99% or more) a plant form acquiring a disease or condition. The phrase “prevent” can be used instead of treatment for this meaning. “Treatment,” as used herein, covers one or more treatments of a disease in a plant, and includes: (a) reducing the risk of occurrence of the disease in a plant predisposed to the disease but not yet diagnosed as infected with the disease (b) impeding the development of the disease, and/or (c) relieving the disease, e.g., causing regression of the disease and/or relieving one or more disease symptoms.

The terms “bacteria” or “bacterium” include, but are not limited to, Gram positive and Gram negative bacteria. Bacteria can include, but are not limited to, Abiotrophia, Achromobacter, Acidaminococcus, Acidovorax, Acinetobacter, Actinobacillus, Actinobaculum, Actinomadura, Actinomyces, Aerococcus, Aeromonas, Afipia, Agrobacterium, Alcaligenes, Alloiococcus, Alteromonas, Amycolata, Amycolatopsis, Anaerobospirillum, Anabaena affinis and other cyanobacteria (including the Anabaena, Anabaenopsis, Aphanizomenon, Camesiphon, Cylindrospermopsis, Gloeobacter Hapalosiphon, Lyngbya, Microcystis, Nodularia, Nostoc, Phormidium, Planktothrix, Pseudoanabaena, Schizothrix, Spirulina, Trichodesmium, and Umezakia genera) Anaerorhabdus, Arachnia, Arcanobacterium, Arcobacter, Arthrobacter, Atopobium, Aureobacterium, Bacteroides, Balneatrix, Bartonella, Bergeyella, Bifidobacterium, Bilophila Branhamella, Borrelia, Bordetella, Brachyspira, Brevibacillus, Brevibacterium, Brevundimonas, Brucella, Burkholderia, Buttiauxella, Butyrivibrio, Calymmatobacterium, Campylobacter, Capnocytophaga, Cardiobacterium, Catonella, Cedecea, Cellulomonas, Centipeda, Chlamydia, Chlamydophila, Chromobacterium, Chyseobacterium, Chryseomonas, Citrobacter, Clostridium, Collinsella, Comamonas, Corynebacterium, Coxiella, Cryptobacterium, Delftia, Dermabacter, Dermatophilus, Desulfomonas, Desulfovibrio, Dialister, Dichelobacter, Dolosicoccus, Dolosigranulum, Edwardsiella, Eggerthella, Ehrlichia, Eikenella, Empedobacter, Enterobacter, Enterococcus, Erwinia, Erysipelothrix, Escherichia, Eubacterium, Ewingella, Exiguobacterium, Facklamia, Filifactor, Flavimonas, Flavobacterium, Francisella, Fusobacterium, Gardnerella, Gemella, Globicatella, Gordona, Haemophilus, Hafnia, Helicobacter, Helococcus, Holdemania Ignavigranum, Johnsonella, Kingella, Klebsiella, Kocuria, Koserella, Kurthia, Kytococcus, Lactobacillus, Lactococcus, Lautropia, Leclercia, Legionella, Leminorella, Leptospira, Leptotrichia, Leuconostoc, Listeria, Listonella, Megasphaera, Methylobacterium, Microbacterium, Micrococcus, Mitsuokella, Mobiluncus, Moellerella, Moraxella, Morganella, Mycobacterium, Mycoplasma, Myroides, Neisseria, Nocardia, Nocardiopsis, Ochrobactrum, Oeskovia, Oligella, Orientia, Paenibacillus, Pantoea, Parachlamydia, Pasteurella, Pediococcus, Peptococcus, Peptostreptococcus, Photobacterium, Photorhabdus, Phytoplasma, Plesiomonas, Porphyrimonas, Prevotella, Propionibacterium, Proteus, Providencia, Pseudomonas, Pseudonocardia, Pseudoramibacter, Psychrobacter, Rahnella, Ralstonia, Rhodococcus, Rickettsia Rochalimaea Roseomonas, Rothia, Ruminococcus, Salmonella, Selenomonas, Serpulina, Serratia, Shewenella, Shigella, Simkania, Slackia, Sphingobacterium, Sphingomonas, Spirillum, Spiroplasma, Staphylococcus, Stenotrophomonas, Stomatococcus, Streptobacillus, Streptococcus, Streptomyces, Succinivibrio, Sutterella, Suttonella, Tatumella, Tissierella, Trabulsiella, Treponema, Tropheryma, Tsakamurella, Turicella, Ureaplasma, Vagococcus, Veillonella, Vibrio, Weeksella, Wolinella, Xanthomonas, Xenorhabdus, Yersinia, and Yokenella. Other examples of bacterium include Mycobacterium tuberculosis, M. bovis, M. typhimurium, M. bovis strain BCG, BCG substrains, M. avium, M. intracellulare, M. africanum, M. kansasii, M. marinum, M. ulcerans, M. avium subspecies paratuberculosis, Staphylococcus aureus, Staphylococcus epidermidis, Staphylococcus equi, Streptococcus pyogenes, Streptococcus agalactiae, Listeria monocytogenes, Listeria ivanovii, Bacillus anthracis, B. subtilis, Nocardia asteroides, and other Nocardia species, Streptococcus viridans group, Peptococcus species, Peptostreptococcus species, Actinomyces israelii and other Actinomyces species, and Propionibacterium acnes, Clostridium tetani, Clostridium botulinum, other Clostridium species, Pseudomonas aeruginosa, other Pseudomonas species, Campylobacter species, Vibrio cholera, Ehrlichia species, Actinobacillus pleuropneumoniae, Pasteurella haemolytica, Pasteurella multocida, other Pasteurella species, Legionella pneumophila, other Legionella species, Salmonella typhi, other Salmonella species, Shigella species Brucella abortus, other Brucella species, Chlamydi trachomatis, Chlamydia psittaci, Coxiella burnetti, Escherichia coli, Neiserria meningitidis, Neiserria gonorrhea, Haemophilus influenzae, Haemophilus ducreyi, other Hemophilus species, Yersinia pestis, Yersinia enterolitica, other Yersinia species, Escherichia coli, E. hirae and other Escherichia species, as well as other Enterobacteria, Brucella abortus and other Brucella species, Burkholderia cepacia, Burkholderia pseudomallei, Francisella tularensis, Bacteroides fragilis, Fudobascterium nucleatum, Provetella species, and Cowdria ruminantium, or any strain or variant thereof. The Gram-positive bacteria may include, but is not limited to, Gram positive Cocci (e.g., Streptococcus, Staphylococcus, and Enterococcus). The Gram-negative bacteria may include, but is not limited to, Gram negative rods (e.g., Bacteroidaceae, Enterobacteriaceae, Vibrionaceae, Pasteurellae and Pseudomonadaceae). In an embodiment, the bacteria can include Mycoplasma pneumoniae.

The term “protozoan” as used herein includes, without limitations flagellates (e.g., Giardia lamblia), amoeboids (e.g., Entamoeba histolitica), and sporozoans (e.g., Plasmodium knowlesi) as well as ciliates (e.g., B. coli). Protozoan can include, but it is not limited to, Entamoeba coli, Entamoeabe histolitica, Iodoamoeba buetschlii, Chilomastix meslini, Trichomonas vaginalis, Pentatrichomonas homini, Plasmodium vivax, Leishmania braziliensis, Trypanosoma cruzi, Trypanosoma brucei, and Myxoporidia.

The term “algae” as used herein includes, without limitations microalgae and filamentous algae such as Anacystis nidulans, Scenedesmus sp., Chlamydomonas sp., Clorella sp., Dunaliella sp., Euglena so., Prymnesium sp., Porphyridium sp., Synechoccus sp., Botryococcus braunii, Crypthecodinium cohnii, cylindrotheca sp., Microcystis sp., Isochrysis sp., Monallanthus salina, M. minutum, Nannochloris sp., Nannochloropsis sp., Neochloris oleoabundans, Nitzschia sp., Phaeodactylum tricornutum, Schizochytrium sp., Senedesmus obliquus, and Tetraselmis sueica as well as algae belonging to any of Spirogyra, Cladophora, Vaucheria, Pithophora and Enteromorpha genera.

The term “fungi” as used herein includes, without limitations, a plurality of organisms such as molds, mildews and rusts and include species in the Penicillium, Aspergillus, Acremonium, Cladosporium, Fusarium, Mucor, Nerospora, Rhizopus, Tricophyton, Botryotinia, Phytophthora, Ophiostoma, Magnaporthe, Stachybotrys and Uredinalis genera.

### DISCUSSION

In accordance with the purpose(s) of the present disclosure, as embodied and broadly described herein, embodiments of the present disclosure, in one aspect, relate to compositions including a copper/silica nanocomposite and a polymer, methods of making a composition, methods of using a composition, and the like. In an embodiment, the composition can be used as an antimicrobial agent to kill and/or inhibit the formation of microorganisms on a surface such as a tree, plant, and the like. An advantage of the present disclosure is that the composition is water soluble, non-phytotoxic, film-forming, and has antimicrobial properties. In particular, the combination of the copper/silica nanocomposite and a polymer in the composition provides for water soluble formulation that can form a film on a surface with enhanced adherence to other compositions not including the polymer, while not degrading the antimicrobial properties of the copper/silica nanocomposite.

In addition, embodiments of the present disclosure provide for a composition that can be used for multiple purposes. Embodiments of the present disclosure are advantageous in that they can slowly release one or more agents that can be used to prevent, substantially prevent and/or treat or substantially treat a disease or condition in a plant, act as an antibacterial and/or antifungal. Another advantage of an embodiment of the present disclosure is that the agent(s) can be controllably released over a long period of time (e.g., from the day of application until a few weeks or months (e.g., about 6 or 8 months)). Another advantage of the present disclosure is that the composition is substantially (e.g., grater than about 95% and about 99%) or completely transparent to visible light or translucent to visible light.

In an embodiment, the composition may have an antimicrobial characteristic (e.g., kills at least 70%, at least 80%, at least 90%, at least 95%, or at least 99% of the microorganisms (e.g., bacteria) on the surface and/or reduces the amount of microorganisms that form or grow on the surface by at least 70%, at least 80%, at least 90%, at least 95%, or at least 99%, as compared to a similar surface without the composition disposed on the surface). Additional details are described in the Examples.

In an embodiment, the composition can be disposed on a surface of a structure. In an embodiment, the structure can include plants such as trees, shrubs, grass, agricultural crops, and the like, includes leaves and fruit. In an embodiment, the composition provides uniform plant surface coverage, substantial uniform plant surface coverage, or substantially covers the plant. In an embodiment, the composition can be used to treat a plant having a disease or to prevent the plant from obtaining a disease.

In an embodiment, the structure can include those that may be exposed to microorganisms and/or that microorganisms can grow on, such as, without limitation, fabrics, cooking counters, food processing facilities, kitchen utensils, food packaging, swimming pools, metals, drug vials, medical instruments, medical implants, yarns, fibers, gloves, furniture, plastic devices, toys, diapers, leather, tiles, and flooring materials. In an embodiment, the structure can include textile articles, fibers, filters or filtration units (e.g., HEPA for air and water), packaging materials (e.g., food, meat, poultry, and the like food packaging materials), plastic structures (e.g., made of a polymer or a polymer blend), glass or glass like structures on the surface of the structure, metals, metal alloys, or metal oxides structure, a structure (e.g., tile, stone, ceramic, marble, granite, or the like), and a combination thereof.

In an embodiment, the copper component can include a copper ion, metallic copper, copper oxide, copper oxychloride, copper sulfate, copper hydroxide, and a combination thereof. The copper component can include copper ions that are electrostatically bound to the silica nanoparticle core or amorphous silica matrix, copper covalently bound to the hydrated surface of the nanoparticle or amorphous silica matrix, and/or copper oxides and/or hydroxides bound to the surface of the nanoparticle or amorphous silica matrix. In an embodiment, the composition includes the copper component in two or in all three of these states.

In an embodiment, the copper component can be in a soluble (amorphous) and an insoluble (crystalline) form. By controlling the soluble and insoluble ratio, the release rate of the copper component can be controlled as a function of time. As a result, the release rate of the copper component can be controlled so that antibacterial and/or antifungal characteristics can be effective for time frames of days to weeks or to months. In other words, the copper component can be released from the multifunctional silica based nanoparticle or gel starting from the day of application and continuing release to about a week, about a month, about two months, about three months, about four months, about five months, about six months, about seven month, or about eight months. The ratio of the soluble to insoluble copper component can be adjusted to control the release rate. In an embodiment, the ratio of the soluble copper to the insoluble copper (e.g., Chelated Cu)_{X} (Crystalline Cu)_{1-X}) can be out 0:1 to 1:0 (X can be about 0.1 to 0.99 or about 0.01 to 1), and can be modified in increments of about 0.01 to produce the ratio that releases the Cu for the desired period of time. Parameters that can be used to adjust the ratio include: solvent polarity and protic nature (i.e., hydrogen bonding capability), Cu nanoparticle precursor (e.g., Cu sulfate) concentration, temperature, concentration of silane precursor (such as tetraethylorthosilicate, TEOS), amount of polymer, type of polymer, and the like. In an embodiment, the copper nanoparticle precursor compound can be an insoluble Cu compounds (e.g., copper hydroxide, cupric chloride, cuprous chloride, cupric oxide, cuprous oxide), a soluble Cu compounds (e.g., copper sulfate, copper nitrate), or a combination thereof. In an embodiment, the silane nanoparticle precursor can be alkyl (C2 to C6) silane, tetraethoxysilane (TEOS), tetramethoxysilane (TMOS), sodium silicate, a silane precursor that can produce silicic acid or silicic acid like intermediates, or a combination thereof.

In an embodiment, the metallic copper can be about 1 microgram (μg)/mL to 20 milligram (mg)/mL weight percent, of the copper/silica-polymer nanocomposite.

“Silica gel matrix” or “silica nanogel matix” refers to amorphous gel like substance that is formed by the interconnection of silica particles (e.g., nanoparticles (e.g., 2 to 500 nm or 5 to 50 nm)) to one another. In an embodiment, the amorphous silica gel has no ordered (e.g., defined) structure (opposite to crystalline structure) so an “amorphous gel” refers to gel material having amorphous structural composition. In an embodiment, the silica nanoparticles of the silica gel are interconnected covalently (e.g., through —Si—O—Si— bonds), physically associated via Van der Waal forces, and/or through ionic interactions (e.g., with copper ions).

In an embodiment, the silica particles are interconnected and copper nanoparticles can be disposed within the silica gel matrix and/or attached to one or more silica particles. In an embodiment, the copper nanoparticles are substantially (e.g., greater than about 80%, about 90%, about 95%, or about 99%) monodisperse. In an embodiment, the silica gel is disposed around the entire copper nanoparticle, which, although not intending to be bound by theory, causes the copper/silica nanocomposite to be transparent to visible light. Embodiments of the present disclosure include the appropriate ratio of silica gel to copper nanoparticle so that the nanocomposite is transparent to visible light, while also maintaining antimicrobial characteristics.

In an embodiment, the diameter of the particles (e.g., silica and/or copper) can be varied from a few nanometers to hundreds of nanometers by appropriately adjusting synthesis parameters, such as amounts of silane precursor, polarity of reaction medium, pH, time or reaction, and the like. For example, the diameter of the particles can be controlled by adjusting the time frame of the reaction. In an embodiment, the silica and copper nanoparticles can independently be about 2 to 25 nm or about 5 to 20 nm. In addition, the concentration of the copper ions can be appropriately adjusting synthesis parameters, such as amounts of silane precursor, polarity of reaction medium, pH, time or reaction, and the like.

As mentioned above, the composition also includes a polymer. Although not intending to be bound by theory, the polymer or polymer copper/silica nanocomposite may increase the solubility of the composition, enhance the film-forming characteristic of the composition, and/or enhance the adherence characteristics of the composition, while not retarding the antimicrobial characteristics of the composition. In an embodiment, the polymer can include one or more of the following: polyacrylamide, polyvinyl alcohol, polyvinyl pyrolidone, polyethyleneimine, polyethylene glycol, polypropylene glycol, polyacrylic acid, dextran, chitosan (e.g., water soluble), alginate, polyvinylpyrrolidone, polyacrylamide, polylactic acid, polyglycolic acid, starch, and a combination thereof (e.g., poly(lactic-co-glycolic acid) (PLGA)). In an embodiment, the ratio of copper/silica nanocomposite to polymer is about 0.1:1 to 3:1 or about 0.5:1 to 2:1. The polymer was added to Cu/Silica nanogel after acid mediated TEOS hydrolysis in acidic conditions. The pH was then raised to about 8 to 9. Based on HRTEM results, the Cu/Silica nanogel integrity remained intact after polymer addition. Therefore, the polymer stabilized Cu/silica nanogel material at higher pHs (e.g., about 6 to 9) by surface interacting with Cu/silica nanogel via intermolecular forces.

In addition, the polymer can include quaternary ammonium compounds such as those described below:

| CAS No. | Quaternary ammonium compound |
|---|---|
| 61789-18-2 | Coco alkyltrimethyl quaternary ammonium chlorides |
| 61790-41-8 | Quaternary ammonium compounds, trimethylsoya alkyl, |
| | chlorides |
| 61791-10-4 | Quaternary ammonium compounds, coco alkylbis(hydroxy- |
| | ethyl)methyl, ethoxylated, chlorides (Data Submitter |
| | Rights) |
| 64755-05-1 | Quaternary ammonium compounds, bis(hydroxy- |
| | ethyl)methyltallow alkyl, ethoxylated, chlorides (Data |
| | Submitter Rights) |
| 67784-77-4 | Quaternary ammonium compounds, bis(hydroxy- |
| | ethyl)methyltallow alkyl, chlorides (Data Submitter Rights) |
| 68187-69-9 | Quaternary ammonium compounds, (hydrogenated tallow |
| | alkyl)bis(hydroxyethyl)methyl, ethoxylated, chlorides (Data |
| | Submitter Rights) |
| 70750-47-9 | Quaternary ammonium compounds, coco alkylbis(hydroxy- |
| | ethyl)methyl chloride (Data Submitter Rights) |
| 8030-78-2 | Tallow trimethyl ammonium chloride |
| 61788-92-9 | Quaternary ammonium compounds, dimethyldisoya alkyl, |
| | chlorides |
| 68424-85-1 | Alkyl* dimethyl benzyl ammonium chloride *(50% C14, |
| | 40% C12, 10% C16) |
| 68918-78-5 | Quaternary ammonium compounds, bis(C8-18 and C18- |
| | unsatd. alkyl)dimethyl, chlorides |
| 68956-79-6 | Alkylbenzyldimethylammonium chlorides, C12-18-alkyl |
| | [(ethylphenyl)methyl] dimethyl |

Furthermore, other polymers can include EPA approved polymers such as in Table A below (Title 40: Protection of the Environment, §180.960 Polymers).

| Polymer | CAS No. |
|---|---|
| Acetic acid ethenyl ester, polymer with ethenol and (α)-2-propenyl- | 137091-12-4 |
| (ω)-hydroxypoly (oxy-1,2-ethanediyl) minimum number average | |
| molecular weight (in amu), 15,000 | |
| Acetic acid ethenyl ester, polymer with 1-ethenyl-2-pyrrolidinone | 25086-89-9 |
| Acetic acid ethenyl ester, polymer with oxirane, minimum number | 25820-49-9 |
| average molecular weight (in amu), 17,000 | |
| Acetic acid ethenyl ester, polymer with sodium 2-methyl-2-[(1-oxo-2- | 924892-37-5 |
| propen-1-yl)amino]-1-propanesulfonate (1:1), hydrolyzed, minimum | |
| number average molecular weight (in amu), 61,000 | |
| Acrylic acid-benzyl methacrylate-1-propanesulfonic acid, 2-methyl-2- | 1152297-42-1 |
| [(1-oxo-2-propenyl)amino]-, monosodium salt, minimum number | |
| average molecular weight (in amu), 1500 | |
| Acrylic acid, polymerized, and its ethyl and methyl esters | None |
| Acrylic acid-sodium acrylate-sodium-2-methylpropanesulfonate | 97953-25-8 |
| copolymer, minimum average molecular weight (in amu), 4,500 | |
| Acrylic acid-stearyl methacrylate copolymer, minimum number | 27756-15-6 |
| average molecular weight (in amu), 2,500 | |
| Acrylic acid, styrene, α-methyl styrene copolymer, ammonium salt, | 89678-90-0 |
| minimum number average molecular weight (in amu), 1,250 | |
| Acrylic acid terpolymer, partial sodium salt, minimum number | 151006-66-5 |
| average molecular weight (in amu), 2,400 | |
| Acrylic polymers composed of one or more of the following | None |
| monomers: Acrylic acid, methyl acrylate, ethyl acrylate, butyl | |
| acrylate, hydroxyethyl acrylate, hydroxypropyl acrylate, hydroxybutyl | |
| acrylate, carboxyethyl acrylate, methacrylic acid, methyl | |
| methacrylate, ethyl methacrylate, butyl methacrylate, isobutyl | |
| methacrylate, hydroxyethyl methacrylate, hydroxypropyl | |
| methacrylate, hydroxybutyl methacrylate, lauryl methacrylate, and | |
| stearyl methacrylate; with none and/or one or more of the following | |
| monomers: Acrylamide, N-methyl acrylamide, N,N-dimethyl | |
| acrylamide, N-octylacrylamide, maleic anhydride, maleic acid, | |
| monoethyl maleate, diethyl maleate, monooctyl maleate, dioctyl | |
| maleate; and their corresponding sodium, potassium, ammonium, | |
| isopropylamine, triethylamine, monoethanolamine, and/or | |
| triethanolamine salts; the resulting polymer having a minimum | |
| number average molecular weight (in amu), 1,200 | |
| Acrylonitrile-butadiene copolymer conforming to 21 CFR 180.22, | 9003-18-3 |
| minimum average molecular weight (in amu), 1,000 | |
| Acrylonitrile-styrene-hydroxypropyl methacrylate copolymer, | None |
| minimum number average molecular weight (in amu), 447,000 | |
| α-alkyl (C₁₂-C₁₅)-ω- | 68551-13-3 |
| hydroxypoly(oxypropylene)poly(oxyethylene)copolymers (where the | |
| poly(oxypropylene) content is 3-60 moles and the poly(oxyethylene) | |
| content is 5-80 moles), the resulting ethoxylated propoxylated | |
| (C₁₂-C₁₅) alcohols having a minimum molecular weight (in amu), 1,500 | |
| α-Alkyl-ω-hydroxypoly (oxypropylene) and/or poly (oxyethylene) | 9035-85-2; 9038-29-3; |
| polymers where the alkyl chain contains a minimum of six carbons | 9038-43-1; 9040-05-5; |
| and a minimum number average molecular weight (in amu) 1,100 | 25190-05-0; 25231-21-4; |
| | 26636-39-5; 27252-75-1; |
| | 37311-00-5; 37311-01-6; |
| | 37311-04-9; 50861-66-0; |
| | 52232-09-4; 59112-62-8; |
| | 62648-50-4; 63303-01-5; |
| | 63658-45-7; 63793-60-2; |
| | 64415-24-3; 64415-25-4; |
| | 64425-86-1; 65104-72-5; |
| | 65150-81-4; 67254-71-1; |
| | 67763-08-0; 68238-81-3; |
| | 68238-82-4; 68409-58-5; |
| | 68409-59-6; 68439-30-5; |
| | 68439-48-5; 68439-53-2; |
| | 68526-95-4; 68603-20-3; |
| | 68920-69-4; 68954-94-9; |
| | 68991-48-0; 69227-20-9; |
| | 70955-07-6; 71011-10-4; |
| | 72066-65-0; 72108-90-8; |
| | 72484-69-6; 73018-31-2; |
| | 74432-13-6; 74499-34-6; |
| | 79771-03-2; 102782-43-4; |
| | 103331-86-8; 103657-84-7; |
| | 103657-85-8; 103819-03-0; |
| | 116810-32-3; 116810-33-4; |
| | 120944-68-5; 121617-09-2; |
| | 126646-02-4; 126950-62-7; |
| | 139626-71-4; 152231-44-2; |
| | 154518-36-2; 157627-88-8; |
| | 157707-41-0; 157707-43-2; |
| | 159653-49-3; 160901-09-7; |
| | 160901-19-9; 160901-20-2; |
| | 161025-21-4; 161025-22-5; |
| | 176022-76-7; 287935-46-0; |
| | 288260-45-7; 303176-75-2; |
| | 954108-36-2 |
| Alkyl (C₁₂-C₂₀) methacrylate-methacrylic acid copolymer, minimum | None |
| molecular weight (in amu), 11,900 | |
| 2H-Azepin-2-one, 1-ethenylhexahydro-, homopolymer | 25189-83-7 |
| 1,3 Benzene dicarboxylic acid, 5-sulfo-, 1,3-dimethyl ester, sodium | 212842-88-1 |
| salt, polymer with 1,3-benzene dicarboxylic acid, 1,4-benzene | |
| dicarboxylic acid, dimethyl 1,4-benzene dicarboxylate and 1,2- | |
| ethanediol, minimum number average molecular weight (in amu), | |
| 2,580 | |
| 3,5-Bis(6-isocyanatohexyl)-2H-1,3,5-oxadiazine-2,4,6-(3H,5H)- | 87823-33-4 |
| trione, polymer with diethylenetriamine, minimum number average | |
| molecular weight (in amu), 1,000,000 | |
| Polymer of one or more diglycidyl ethers of bisphenol A, resorcinol, | None |
| glycerol, cyclohexanedimethanol, neopentyl glycol, and polyethylene | |
| glycol with one or more of the following: Polyoxypropylene diamine, | |
| polyoxypropylene triamine, N-aminoethyl-piperazine, trimethyl-1,6- | |
| hexanediamine isophorone diamine, N,N-dimethyl-1,3- | |
| diaminopropane, nadic methyl anhydride, 1,2-cyclohexane- | |
| dicarboxylic anhydride and 1,2,3,6-tetrahydrophthalic anhydride, | |
| minimum number average molecular weight (in amu), 400,000 | |
| Butadiene-styrene copolymer | None |
| 1,4-Butanediol-methylenebis(4-phenylisocyanate)- | 9018-04-6 |
| poly(tetramethylene glycol) copolymer, minimum molecular weight | |
| (in amu) 158,000 | |
| Butene, homopolymer | 9003-29-6 |
| 2-butenedioic acid (2Z)-, monobutyl ester, polymer with | 205193-99-3 |
| methoxyethene, sodium salt, minimum number average molecular | |
| weight (in amu), 18,200 | |
| 2-Butenedioic acid (Z)-, polymer with ethenol and ethenyl acetate, | 139871-83-3 |
| sodium salt, minimum number average molecular weight (in amu), | |
| 75,000 | |
| Butyl acrylate-vinyl acetate-acrylic acid copolymer, minimum number | 65405-40-5 |
| average molecular weight (in amu), 18,000 | |
| Carbonic acid, diethyl ester, polymer with α-hydro-ω- | 1147260-65-8 |
| hydroxypoly[oxy(methyl-1,2-ethanediyl)] ether with 2-ethyl-2- | |
| (hydroxymethyl)-1,3-propanediol (3:1), ester with α-[[[[5- | |
| (carboxyamino)-1,3,3-trimethylcyclohexyl]methyl]amino]carbonyl]-ω- | |
| methoxypoly(oxy-1,2-ethanediyl), minimum number average | |
| molecular weight (in amu), 1,900 | |
| Castor oil, ethoxylated, dioleate, minimum number average | 110531-96-9 |
| molecular weight (in amu), 1260. | |
| Castor oil, ethoxylated, oleate, minimum number average molecular | 220037-02-5 |
| weight (in amu), 1,600 | |
| Castor oil, polymer with adipic acid, linoleic acid, oleic acid and | 1357486-09-9 |
| ricinoleic acid, minimum number average molecular weight (in amu), | |
| 3,500 | |
| Castor oil, polyoxyethylated; the poly(oxyethylene) content averages | None |
| 5-54 moles | |
| Chlorinated polyethylene | 64754-90-1 |
| Cross-linked nylon-type polymer formed by the reaction of a mixture | None |
| of sebacoyl chloride and polymethylene polyphenylisocycanate with | |
| a mixture of ethylenediamine and diethylenetriamine | |
| Cross-linked polyurea-type encapsulating polymer | None |
| Dimethylpolysiloxane minimum number average molecular weight (in | 63148-62-9 |
| amu), 6,800 | |
| Dimethyl silicone polymer with silica, minimum number average | 67762-90-7 |
| molecular weight (in amu), 1,100,000 | |
| α-(o,p-Dinonylphenyl)-ω-hydroxypoly(oxyethylene) produced by | 9014-93-1 |
| condensation of 1 mole of dinonylphenol (nonyl group is a propylene | |
| trimer isomer) with an average of 140-160 moles of ethylene oxide | |
| Docosyl methacrylate-acrylic acid copolymer, or docosyl | None |
| methacrylate-octadecyl methacrylate-acrylic acid copolymer, | |
| minimum number average molecular weight (in amu), 3,000 | |
| 1,12-Dodecanediol dimethacrylate polymer, minimum molecular | None |
| weight (in amu), 100,000 | |
| α-(p-Dodecylphenyl)-ω-hydroxypoly(oxyethylene) produced by the | 9014-92-0 |
| condensation of 1 mole of dodecylphenol (dodecyl group is a | 26401-47-8 |
| propylene tetramer isomer) with an average of 30-70 moles of | |
| ethylene oxide | |
| 1,2-Ethanediamine, N1-(2-aminoethyl)-, polymer with 2,4- | 35297-61-1 |
| diisocyanato-1-methylbenzene, minimum number average molecular | |
| weight (in amu), one million | |
| 1,2-Ethanediamine, polymer with methyl oxirane and oxirane, | 26316-40-5 |
| minimum number average molecular weight (in amu), 1,100 | |
| Ethylene glycol dimethyacrylate-lauryl methacrylate copolymer, | None |
| minimum molecular weight (in amu), 100,000 | |
| Ethylene glycol dimethacrylate polymer, minimum molecular weight | None |
| (in amu), 100,000 | |
| Fatty acids, tall-oil, ethoxylated propoxylated, minimum number | 67784-86-5 |
| average molecular weight (in amu), 2,009 | |
| Formaldehyde, polymer with α-[bis(1-phenylethyl)phenyl]-ω- | 157291-93-5 |
| hydroxypoly(oxy-1,2-ethanediyl), number average molecular weight | |
| (in amu), 1,803 | |
| Formaldehyde, polymer with 2-methyloxirane and 4-nonylphenol, | 37523-33-4 |
| minimum number average molecular weight (in amu), 4,000 | |
| Fumaric acid-isophthalic acid-styrene-ethylene/propylene glycol | None |
| copolymer, minimum average molecular weight (in amu), 1 × 10¹⁸ | |
| 2,5-Furandione, polymer with ethenylbenzene, hydrolyzed, 3- | 1062609-13-5 |
| (dimethylamino)propyl imide, imide with polyethylene-polypropylene | |
| glycol 2-aminopropyl me ether, 2,2′-(1,2-diazenediyl)bis[2- | |
| methylbutanenitrile]-initiated, minimum number average molecular | |
| weight (in amu), 5,816 | |
| 2,5-Furandione, polymer with ethenylbenzene, reaction products | 162568-32-3 |
| with polyethylene-polypropylene glycol 2-aminopropyl Me ether; | |
| minimum number average molecular weight (in amu), 14,000 | |
| Hexadecyl acrylate-aerylic acid copolymer, hexadecyl acrylate-butyl | None |
| acrylate-acrylic acid copolymer, or hexadecyl acrylate-dodecyl | |
| acrylate-acrylic acid copolymer, minimum number average molecular | |
| weight (in amu), 3,000 | |
| Hexamethyl disilizane, reaction product with silica, minimum number | 68909-20-6 |
| average molecular weight (in amu), 645,000 | |
| 1,6-Hexanediol dimethyacrylate polymer, minimum molecular weight | None |
| (in amu), 100,000 | |
| α-Hydro-ω-hydroxy-poly(oxyethylene) C8 alkyl ether citrates, | 330977-00-9 |
| poly(oxyethylene) content is 4-12 moles, minimum number average | |
| molecular weight (in amu) 1,300 | |
| α-Hydro-ω-hydroxy-poly(oxyethylene) C10-C16-alkyl ether citrates, | 330985-58-5 |
| poly(oxyethylene) content is 4-12 moles, minimum number average | |
| molecular weight (in amu) 1,100 | |
| α-Hydro-ω-hydroxy-poly(oxyethylene) C16-C18-alkyl ether citrates, | 330985-61-0 |
| poly(oxyethylene) content is 4-12 moles, minimum number average | |
| molecular weight (in amu) 1,300 | |
| α-Hydro-ω-hydroxypoly(oxyethylene), minimum number average | 25322-68-3 |
| molecular weight (in amu), 17,000 | |
| α-Hydro-ω-hydroxypoly(oxyethylene)poly (oxypropylene) | None |
| poly(oxyethylene) block copolymer; the minimum poly(oxypropylene) | |
| content is 27 moles and the minimum molecular weight (in amu) is | |
| 1,900 | |
| α-Hydro-ω-hydroxypoly(oxypropylene); minimum molecular weight | None |
| (in amu) 2,000 | |
| 12-Hydroxystearic acid-polyethylene glycol copolymer, minimum | 70142-34-6 |
| number average molecular weight (in amu), 3,690 | |
| Isodecyl alcohol ethoxylated (2-8 moles) polymer with chloromethyl | None |
| oxirane, minimum number average molecular weight (in amu) 2,500 | |
| Lauryl methacrylate-1,6-hexanediol dimethacrylate copolymer, | None |
| minimum molecular weight (in amu), 100,000 | |
| Maleic acid-butadiene copolymer | None |
| Maleic acid monobutyl ester-vinyl methyl ether copolymer, minimum | 25119-68-0 |
| average molecular weight (in amu), 52,000 | |
| Maleic acid monoethyl ester-vinyl methyl ether copolymer, minimum | 25087-06-3 |
| average molecular weight (in amu), 46,000 | |
| Maleic acid monoisopropyl ester-vinyl methyl ether copolymer, | 31307-95-6 |
| minimum average molecular weight (in amu), 49,000 | |
| Maleic anhydride-diisobutylene copolymer, sodium salt, minimum | 37199-81-8 |
| number average molecular weight (in amu) 5,0007-18,000 | |
| Maleic anhydride-methylstyrene copolymer sodium salt, minimum | 60092-15-1 |
| number average molecular weight (in amu), 15,000 | |
| Maleic anhydride-methyl vinyl ether, copolymer, average molecular | None |
| weight (in amu), 250,000 | |
| Methacrylic acid-methyl methacrylate-polyethylene glycol methyl | 100934-04-1 |
| ether methacrylate copolymer, minimum number averge molecular | |
| weight (in amu), 3,700 | |
| Methacrylic acid-methyl methacrylate-polyethylene glycol | 111740-36-4 |
| monomethyl ether methacrylate graft copolymer, minimum number | |
| average molecular weight (in amu), 1,800 | |
| Methacrylic copolymer, minimum number average molecular weight | 63150-03-8 |
| (in amu), 15,000 | |
| Methyl methacrylate-methacrylic acid-monomethoxypolyethylene | 119724-54-8 |
| glycol methacrylate copolymer,) minimum number average | |
| molecular weight (in amu), 2,730 | |
| Methyl methacrylate-2-sulfoethyl methacrylate- | None |
| dimethylaminoethylmethacrylate-glycidyl methacrylate-styrene-2- | |
| ethylhexyl acrylate graft copolymer, minimum average molecular | |
| weight (in amu), 9,600 | |
| Methyl vinyl ether-maleic acid copolymer), minimum number | 25153-40-6 |
| average molecular weight (in amu), 75,000 | |
| Methyl vinyl ether-maleic acid copolymer, calcium sodium salt, | 62386-95-2 |
| minimum number average molecular weight (in amu), 900,000 | |
| Monophosphate ester of the block copolymer α-hydro-ω- | None |
| hydroxypoly(oxyethylene) poly(oxypropylene) poly(oxyethylene); the | |
| poly(oxypropylene) content averages 37-41 moles, average | |
| molecular weight (in amu), 8,000 | |
| α-(p-Nonylphenyl)-ω-hydroxypoly(oxyethylene) mixture of | None |
| dihydrogen phosphate and monohydrogen phosphate esters and the | |
| corresponding ammonium, calcium, magnesium, | |
| monoethanolamine, potassium, sodium, and zinc salts of the | |
| phosphate esters; the nonyl group is a propylene trimer isomer and | |
| the poly(oxyethylene) content averages 30 moles | |
| α-(p-Nonylphenyl)-ω-hydroxypoly(oxyethylene) sulfate, and its | None |
| ammonium, calcium, magnesium, monoethanolamine, potassium, | |
| sodium, and zinc salts; the nonyl group is a propylene trimer isomer | |
| and the poly(oxyethylene) content averages 30-90 moles of ethylene | |
| oxide | |
| α-(p-Nonylphenyl-ω-hydroxypoly(oxypropylene) block polymer with | None |
| poly(oxyethylene); polyoxypropylene content of 10-60 moles; | |
| polyoxyethylene content of 10-80 moles; molecular weight (in amu), | |
| 1,200-7,100. | |
| α-(p-Nonylphenyl)poly(oxypropylene) block polymer with | 37251-69-7 |
| poly(oxyethylene); poly oxyethylene content 30 to 90 moles; | |
| minimum number average molecular weight (in amu), 1,889 | |
| Octadecanoic Acid, 12-Hydroxy-, Homopolymer Ester with 2- | 1373125-59-7 |
| Methylloxirane Polymer with Oxirane monobutyl Ether, minimum | |
| number average molecular weight (in amu), 4,500 | |
| Octadecanoic acid, 12-hydroxy-, homopolymer, octadecanoate | 58128-22-6) |
| minimum number average molecular weight (in amu), 1,370 | |
| α-cis-9-Octadecenyl-ω-hydroxypoly(oxyethylene); the octadecenyl | None |
| group is derived from oleyl alcohol and the poly(oxyethylene) content | |
| averages 20 moles | |
| Octadecyl acrylate-acrylic acid copolymer, octadecyl acrylate- | None |
| dodecyl acrylate-acrylic acid copolymer, octadecyl methacrylate- | |
| butyl acrylate-acrylic acid copolymer, octadecyl methacrylate-hexyl | |
| acrylate-acrylic acid copolymer, octadecyl methacrylate-dodecyl | |
| acrylate-acrylic acid copolymer, or octadecyl methacrylate-dodecyl | |
| methacrylate-acrylic acid copolymer, minimum number average | |
| molecular weight (in amu) 3,000 | |
| Oleic acid diester of α-hydro-ω-hydroxypoly(oxyethylene); the | None |
| poly(oxyethylene), average molecular weight (in amu), 2,300 | |
| 2-oxepanone, homopolymer, minimum number average molecular | 24980-41-4 |
| weight (in amu) 52,000 | |
| Oxirane, decyl-, reaction products with polyethylene-polypropylene | 903890-89-1 |
| glycol ether with trimethylolpropane (3:1) | |
| Oxirane, hexadecyl-, reaction products with polyethylene- | 893427-80-0 |
| polypropylene glycol ether with trimethylolpropane (3:1) | |
| Oxirane, 2-methyl-, polymer with oxirane, dimethyl ether, minimum | 61419-46-3 |
| number average molecular weight (in amu), 2,800 | |
| Oxirane, methyl-, polymer with oxirane, ether with 2-ethyl-2- | 903890-90-4 |
| (hydroxymethyl)-1,3-propanediol (3:1), reaction products with | |
| tetradecyloxirane | |
| Oxirane, methyl-, polymer with oxirane, mono[2-(2-butoxyethoxy) | 85637-75-8 |
| ethyl] ether, minimum number average molecular weight (in amu), | |
| 2,500 | |
| Oxirane, methyl-, polymer with Oxirane, Monobutyl Ether | 9038-95-3 |
| Oxirane, 2-methyl-, polymer with oxirane, minimum number average | 9003-11-6 |
| molecular weight (in amu), 1,100 | |
| Oxirane, 2-methyl-, polymer with oxirane, mono [2-[2-(2- | 926031-36-9 |
| butoxymethylethoxy)methylethoxy]methylethyl] ether, minimum | |
| number average molecular weight (in amu), 3,000 | |
| Polyamide polymer derived from sebacic acid, vegetable oil acids | None |
| with or without dimerization, terephthalic acid and/or | |
| ethylenediamine | |
| Polyethylene glycol-polyisobutenyl anhydride-tall oil fatty acid | 68650-28-2 |
| copolymer, minimum number average molecular weight (in amu), | |
| 2,960 | |
| Polyethylene, oxidized, minimum number average molecular weight | None |
| (in amu), 1,200 | |
| Polymers produced by the reaction of either 1,6-hexanediisocyanate; | 1161844-26-3, 1161844-30-9, |
| 2,4,4-trimethyl-1,6-hexanediisocyanate; 5-isocyanato-1- | 1161844-43-4, 1161844-51-4, |
| (isocyanatomethyl)-fxsp0; 1,3,3fxsp0; -trimethylcyclohexane | 1161844-53-6, 693252-31-2, |
| (isophoronediisocyanate); 4,4′-methylene-bis-1,1′- | 162993-60-4, 630102-86-2 |
| cyclohexanediisocyanate; 4,4′-methylene-bis-1,1′ | |
| benzyldiisocyanate; or 1,3-bis-(2-isocyanatopropan-2-yl)benzene | |
| with polyethylene glycol and end-capped with one or a mixture of | |
| more than one of octanol, decanol, dodecanol, tetradecanol, | |
| hexadecanol, octadecanol, and octadec-9-enol or polyethyleneglycol | |
| ethers of octanol, decanol, dodecanol, tetradecanol, hexadecanol, | |
| octadecanol, and octadec-9-enol, minimum number average | |
| molecular weight (in amu), 20,000 | |
| Polymethylene polyphenylisocyanate, polymer with ethylene | None |
| diamine, diethylene triamine and sebacoyl chloride, cross-linked; | |
| minimum number average molecular weight (in amu), 100,000 | |
| Polyoxyalkylated glycerol fatty acid esters; the mono-, di-, or | 61791-23-9, 68201-46-7, |
| triglyceride mixtures of C₈ through C₂₂, primarily C₈ through C₁₈ | 68440-49-3, 68458-88-8, |
| saturated and unsaturated, fatty acids containing up to 15% water by | 68606-12-2, 68648-38-4, |
| weight reacted with a minimum of three moles of either ethylene | 70377-91-2, 70914-02-2, |
| oxide or propylene oxide; the resulting polyoxyalkylated glycerol | 72245-12-6, 72698-41-3, |
| ester polymer minimum number average molecular weight (in amu), | 180254-52-8, 248273-72-5, |
| 1,500 | 308063-50-5, 952722-33-7 |
| Poly(oxy-1,2-ethanediyl), α-hydro-ω-hydroxy-, polymer with 1,1′- | 39444-87-6 |
| methylene-bis-[4-isocyanatocyclohexane], minimum number | |
| average molecular weight (in amu), 1800 | |
| Polyoxyethylated primary amine (C₁₄-C₁₈); the fatty amine is derived | None |
| from an animal source and contains 3% water; the poly(oxyethylene) | |
| content averages 20 moles | |
| Polyoxyethylated sorbitol fatty acid esters; the polyoxyethylated | None |
| sorbitol solution containing 15% water is reacted with fatty acids | |
| limited to C₁₂, C₁₄, C₁₆, and C₁₈, containing minor amounts of | |
| associated fatty acids; the poly(oxyethylene) content averages 30 | |
| moles. | |
| Polyoxyethylated sorbitol fatty acid esters; the sorbitol solution | None |
| containing up to 15% water is reacted with 20-50 moles of ethylene | |
| oxide and aliphatic alkanoic and/or alkenoic fatty acids C₈ through | |
| C₂₂ with minor amounts of associated fatty acids; the resulting | |
| polyoxyethylene sorbitol ester having a minimum molecular weight | |
| (in amu), 1,300 | |
| Poly(oxyethylene/oxypropylene) monoalkyl (C₆-C₁₀) ether sodium | 102900-02-7 |
| fumarate adduct, minimum number average molecular weight (in | |
| amu), 1,900 | |
| Polyoxymethylene copolymer, minimum number average molecular | None |
| weight (in amu), 15,000 | |
| Poly(oxypropylene) block polymer with poly(oxyethylene), molecular | None |
| weight (in amu), 1,800-16,000 | |
| Poly(phenylhexylurea), cross-linked, minimum average molecular | None |
| weight (in amu), 36,000 | |
| Polypropylene | 9003-07-0 |
| Polystyrene, minimum number average molecular weight (in amu), | 9003-53-6 |
| 50,000 | |
| Polytetrafluoroethylene | 9002-84-0 |
| Polyvinyl acetate, copolymer with maleic anhydride, partially | None |
| hydrolyzed, sodium salt, minimum number average molecular weight | |
| (in amu), 53,000 | |
| Polyvinylpyrrolidone butylated polymer, minimum number average | 26160-96-3 |
| molecular weight (in amu), 9,500 | |
| Polyvinyl acetate, minimum molecular weight (in amu), 2,000 | None |
| Polyvinyl acetate-polyvinyl alcohol copolymer, minimum number | 25213-24-5 |
| average molecular weight (in amu), 50,000 | |
| Polyvinyl alcohol | 9002-89-5 |
| Polyvinyl chloride | None |
| Polyvinyl chloride, minimum number average molecular weight (in | 9002-86-2 |
| amu), 29,000 | |
| Poly(vinylpyrrolidone), minimum number average molecular weight | 9003-39-8 |
| (in amu), 4,000 | |
| Poly(vinylpyrrolidone-1-eicosene), minimum average molecular | 28211-18-9 |
| weight (in amu), 3,000 | |
| Poly(vinylpyrrolidone-1-hexadecene), minimum average molecular | 63231-81-2 |
| weight (in amu), 4,700 | |
| 1-propanesulfonic acid, 2-methyl-2-[(1-oxo-2-propenyl)amino]-, | 107568-12-7 |
| monosodium salt, polymer with ethenol and ethenyl acetate, | |
| minimum number average molecular weight (in amu) 50,000 | |
| 2-Propene-1-sulfonic acid sodium salt, polymer with ethenol and | None |
| ethenyl acetate, number average molecular weight (in amu) 6,000- | |
| 12,000 | |
| 2-propenoic acid, butyl ester, polymer with ethenylbenzene, methyl | 27306-39-4 |
| 2-methyl-2-propenoate and 2-propenoic acid (in amu), 1900. | |
| 2-Propenoic acid, butyl ester, polymer with ethyl 2-propenoate and | 33438-19-6 |
| N-(hydroxymethyl)-2-propenamide, minimum number average | |
| molecular weight (in amu), 30,000 | |
| 2-Propenoic acid, 2-ethylhexyl ester, polymer with ethenylbenzene | 25153-46-2 |
| 14,000 daltons | |
| 2-Propenoic acid, 2-ethylhexyl ester, polymer with ethenylbenzene | 68240-06-2 |
| and 2-methylpropyl 2-methyl-2-propenoate, minimum number | |
| average molecular weight (in amu), 18,000 | |
| 2-Propenoic acid, 2-hydroxyethyl ester, polymer with α-[4- | 1007234-89-0 |
| ethenyloxy)butyl]-ω-hydroxypoly (oxy-1,2-ethanediyl), minimum | |
| number average molecular weight (in amu), 17,000 | |
| 2-propenoic acid, 2-methyl-, C12-16-alkyl esters, telomers with 1- | 950207-35-9 |
| dodecanethiol, polyethylene-polypropylene glycol ether with | |
| propylene glycol monomethacrylate (1:1), and styrene 2,2′-(1,2- | |
| diazenediyl)bis[2-methylbutanenitrile]-initiated, minimum number | |
| average molecular weight (in amu), 4,000 | |
| 2-Propenoic acid, methyl ester, polymer with ethenyl acetate, | 886993-11-9 |
| hydrolyzed, sodium salts | |
| 2-Propenoic acid, 2-methyl-, 2-ethylhexyl ester, telomer with 1- | 1283712-50-4 |
| dodecanethiol, ethenylbenzene and 2-methyloxirane polymer with | |
| oxirane monoether with 1,2-propanediol mono(2-methyl-2- | |
| propenoate), hydrogen 2-sulfobutanedioate, sodium salt, 2,2′-(1,2- | |
| diazenediyl)bis[2-methylpropanenitrile]-initiated, minimum number | |
| average molecular weight (in amu), 1,200 | |
| 2-Propenoic acid, 2-methyl-, phenylmethyl ester, polymer with 2- | CASRN 1246766-57-3 |
| propenoic acid and sodium 2-methyl-2-[(1-oxo-2-propen-1-yl)amino]- | |
| 1-propanesulfonate (1:1), peroxydisulfuric acid ([HO)S(O)2]202) | |
| sodium salt (1:2)-initiated minimum number average molecular | |
| weight >1,000 Daltons; maximum number average molecular weight | |
| 10,000 Daltons | |
| 2-Propenoic acid, 2-methyl-, polymer with butyl 2-propenoate and | 25036-16-2 |
| ethenylbenzene, minimum number average molecular weight (in | |
| amu), 17,000 | |
| 2-Propenoic acid, 2-Methyl-, Polymer with Butyl 2-Propenoate, | 153163-36-1 |
| Methyl 2-Methyl-2-Propenoate, Methyl 2-Propenoate and 2- | |
| Propenoic Acid, graft, Compound with 2-Amino-2-Methyl-1-Propanol | |
| 2-Propenoic Acid, 2-Methyl-, Polymer with Ethenylbenzene, 2- | 146753-99-3 |
| Ethylhexyl 2-Propenoate, 2-Hydroxyethyl 2-Propenoate, N- | |
| Hydroxymethyl)-2-Methyl-2-Propenamide and Methyl 2-Methyl-2- | |
| Propenoate, Ammonium Salt | |
| 2-Propenoic acid, 2-methyl-, polymers with Bu acrylate, Et acrylate, | 890051-63-5 |
| Me methacrylate and polyethylene glycol methacrylate C₁₆₋₁₈-alkyl | |
| ethers, minimum number average molecular weight (in amu), 13,000 | |
| 2-Propenoic acid, 2-methyl-, telomer with 2-ethylhexyl 2-propenoate, | 1260001-65-7 |
| 2-propanol and sodium 2-methyl-2-[(1-oxo-2-propen-1-yl) amino]-1- | |
| propanesulfonate (1:1), sodium salt, minimum number average | |
| molecular weight (in amu): 2,900 | |
| 2-Propenoic acid, monoester with 1,2-propanediol, polymer with α- | 955015-23-3 |
| [4-(ethenyloxy) butyl]-ω-hydroxypoly (oxy-1,2-ethanediyl) and 2,5- | |
| furandione, minimum number average molecular weight (in amu), | |
| 25,000 | |
| 2-propenoic acid polymer, with 1,3-butadiene and ethenylbenzene, | 25085-39-6 |
| minimum number average molecular weight (in amu), 9400 | |
| 2-Propenoic acid, polymer with ethenylbenzene and (1- | 129811-24-1 |
| methylethenyl) benzene, sodium salt, minimum number average | |
| molecular weight (in amu), 2,800 | |
| 2-Propenoic acid, polymer with α-[4-(ethenyloxy) butyl]-ω- | 251479-97-7 |
| hydroxypoly (oxy-1,2-ethanediyl) and 2,5-furandione, sodium salt, | |
| minimum number average molecular weight (in amu), 25,000 | |
| 2-Propenoic acid, polymer with α-[4-(ethenyloxy) butyl]-ω- | 518026-64-7 |
| hydroxypoly (oxy-1,2-ethanediyl) and 1,2-propanediol mono-2- | |
| propenoate, potassium sodium salt, minimum number average | |
| molecular weight (in amu), 16,000 | |
| 2-Propenoic acid, polymer with α-[4-(ethenyloxy) butyl]-ω- | 250591-84-5 |
| hydroxypoly (oxy-1,2-ethanediyl), sodium salt, minimum number | |
| average molecular weight (in amu), 24,000 | |
| 2-Propenoic acid, polymer with 2-propenamide, sodium salt, | 25085-02-3 |
| minimum number average molecular weight (in amu), 18,000 | |
| 2-Propenoic acid, sodium salt, polymer with 2-propenamide, | 25987-30-8 |
| minimum number average molecular weight (in amu), 18,000 | |
| 2-Propenoic, 2-methyl-, polymers with ethyl acrylate and | 888969-14-0 |
| polyethylene glycol methylacrylate C₁₈₋₂₂ alkyl ethers | |
| 2-Pyrrolidone, 1-ethenyl-, polymer with ethenol, minimum number | 26008-54-8 |
| average molecular weight (in amu), 23,000 | |
| Silane, dichloromethyl- reaction product with silica minimum number | 68611-44-9 |
| average molecular weight (in amu), 3,340,000 | |
| Silane, trimethoxy[3-(oxiranylmethoxy)propyl]-, hydrolysis products | 68584-82-7 |
| with silica, minimum number average molecular weight (in amu), | |
| 640,000 | |
| Silicic acid, sodium salt, reaction products with chlorotrimethylsilane | None |
| and iso-propyl alcohol, reaction with poly(oxypropylene)- | |
| poly(oxyethylene) glycol, minimum number average molecular | |
| weight (in amu), 75,000 | |
| Sodium polyflavinoidsulfonate, consisting chiefly of the copolymer of | None |
| catechin and leucocyanidin | |
| Soybean oil, ethoxylated; the poly(oxyethylene) content averages 10 | 61791-23-9 |
| moles or greater | |
| Starch, oxidized, polymers with Bu acrylate, tert-Bu acrylate and | 204142-80-3 |
| styrene, minimum number average molecular weight (in amu), | |
| 10,000 | |
| Stearyl methacrylate-1,6-hexanediol dimethacrylate copolymer, | None |
| minimum molecular weight (in amu), 100,000 | |
| Styrene, copolymers with acrylic acid and/or methacrylic acid, with | None |
| none and/or one or more of the following monomers: | |
| Acrylamidopropyl methyl sulfonic acid, methallyl sulfonic acid, 3- | |
| sulfopropyl acrylate, 3-sulfopropyl methacrylate, hydroxypropyl | |
| methacrylate, hydroxypropyl acrylate, hydroxyethyl methacrylate, | |
| hydroxyethyl acrylate, and/or lauryl methacrylate; and its sodium, | |
| potassium, ammonium, monoethanolamine, and triethanolamine | |
| salts; the resulting polymer having a minimum number average | |
| molecular weight (in amu), 1200 | |
| Styrene-ethylene-propylene block copolymer, minimum number | 108388-87-0 |
| average molecular weight (in amu), 125,000 | |
| Styrene, 2-ethylhexyl acrylate, butyl acrylate copolymer, minimum | 30795-23-4 |
| number average molecular weight (in amu), 4,200 | |
| Styrene-2-ethylhexyl acrylate-glycidyl methacrylate-2-acrylamido-2- | None |
| methylpropanesulfonic acid graft copolymer, minimum number | |
| average molecular weight (in amu), 12,500 | |
| Styrene-maleic anhydride copolymer | None |
| Styrene-maleic anhydride copolymer, ester derivative | None |
| Tall oil, polymer with polyethylene glycol and succinic anhydride | 1398573-80-2 |
| monopolyisobutylene derivs., minimum number average molecular | |
| weight (in amu), 1,200 | |
| Tetradecyl acrylate-acrylic acid copolymer, minimum number | None |
| average molecular weight (in amu), 3,000 | |
| Tetraethoxysilane, polymer with hexamethyldisiloxane, minimum | 104133-09-7 |
| number average molecular weight (in amu), 2,500 | |
| Tetraethoxysilane, polymer with hexamethyldisiloxane, minimum | 104133-09-7 |
| number average molecular weight (in amu), 6,500 | |
| α-[p-(1,1,3,3-Tetramethylbutyl)phenyl]-ω-hydroxypoly(oxyethylene) | 9036-19-5 |
| produced by the condensation of 1 mole of p-(1,1,3,3- | 9002-93-1 |
| tetramethylbutyl)phenol with a range of 30-70 moles of ethylene | |
| oxide | |
| α-[p-(1,1,3,3-Tetramethylbutyl)phenyl] poly(oxypropylene) block | None |
| polymer with poly(oxyethylene); the poly(oxypropylene) content | |
| averages 25 moles, the poly(oxyethylene) content averages 40 | |
| moles, the molecular weight (in amu) averages 3,400 | |
| α-[2,4,6-Tris[1-(phenyl)ethyl]phenyl]-ω-hydroxy poly(oxyethylene) | None |
| poly(oxypropylene) copolymer, the poly(oxypropylene) content | |
| averages 2-8 moles, the poly(oxyethylene) content averages 16- | |
| 30 moles, average molecular weight (in amu), 1,500 | |
| Urea-formaldehyde copolymer, minimum average molecular weight | 9011-05-6 |
| (in amu), 30,000 | |
| Vinyl acetate-allyl acetate-monomethyl maleate copolymer, minimum | None |
| average molecular weight (in amu), 20,000 | |
| Vinyl acetate-ethylene copolymer, minimum number average | 24937-78-8 |
| molecular weight (in amu), 69,000 | |
| Vinyl acetate polymer with none and/or one or more of the following | None |
| monomers: Ethylene, propylene, N-methyl acrylamide, acrylamide, | |
| monoethyl maleate, diethyl maleate, monooctyl maleate, dioctyl | |
| maleate, maleic anhydride, maleic acid, octyl acrylate, butyl acrylate, | |
| ethyl acrylate, methyl acrylate, acrylic acid, octyl methacrylate, butyl | |
| methacrylate, ethyl methacrylate, methyl methacrylate, methacrylic | |
| acid, carboxyethyl acrylate, and diallyl phthalate; and their | |
| corresponding sodium, potassium, ammonium, isopropylamine, | |
| triethylamine, monoethanolamine and/or triethanolamine salts; the | |
| resulting polymer having a minimum number average molecular | |
| weight (in amu), 1,200 | |
| Vinyl acetate-vinyl alcohol-alkyl lactone copolymer, minimum | None |
| number average molecular weight (in amu), 40,000; minimum | |
| viscosity of 18 centipoise | |
| Vinyl alcohol-disodium itaconate copolymer, minimum average | None |
| molecular weight (in amu), 50,290 | |
| Vinyl alcohol-vinyl acetate copolymer, benzaldehyde-o-sodium | None |
| sulfonate condensate, minimum number average molecular weight | |
| (in amu), 20,000 | |
| Vinyl alcohol-vinyl acetate-monomethyl maleate, sodium salt-maleic | None |
| acid, disodium salt-γ-butyrolactone acetic acid, sodium salt | |
| copolymer, minimum number average molecular weight (in amu), | |
| 20,000 | |
| Vinyl chloride-vinyl acetate copolymers | None |
| Vinyl pyrrolidone-acrylic acid copolymer, minimum number average | 28062-44-4 |
| molecular weight (in amu), 6,000 | |
| Vinyl pyrrolidone-dimethylaminoethylmethacrylate copolymer, | 30581-59-0 |
| minimum number average molecular weight (in amu), 20,000 | |
| Vinyl pyrrolidone-styrene copolymer | 25086-29-7 |

In an embodiment, a silica precursor material to make the copper/silica nanocomposite can be made by mixing a silane compound (e.g., alkyl silane, tetraethoxysilane (TEOS), tetramethoxysilane, sodium silicate, or a silane precursor that can produce silicic acid or silicic acid like intermediates and a combination of these silane compounds) with a copper precursor compound (e.g. copper hydroxide and the like)), in an acidic medium (e.g., acidic water). In an embodiment, the pH can be adjusted to about 1.0 to 3.5 using a mineral acid such as nitric acid or hydrochloric acid. In an embodiment, the weight ratio of the silica precursor material to the copper precursor compound can be about 0.1:1 to 3:1. After mixing for a period of time (e.g., about 30 minutes to a few hours or about 12 to 36 hours), a mixture including silica nanoparticles with the copper nanoparticles can be formed. Subsequently, the medium can be brought to a pH of about 7 and held for a time period (e.g., a few hours to a day) to form a silica nanoparticle gel, where the silica nanoparticles are interconnected. In an embodiment, the copper nanoparticles can be part of the interconnection of the silica nanoparticles and/or dispersed within the matrix, while copper ions can be dispersed within the matrix as well. Next a polymer can be added to the mixture having an acidic pH. The mixture is stirred for about 12 to 36 hours. Subsequently, the pH is raised to about 4 using a base to form the composition. This process can be performed using a single reaction vessel or can use multiple reaction vessels.

In an embodiment, after the composition is disposed on the surface, the structure may have an antimicrobial characteristic that is capable of killing a substantial portion of the microorganisms (e.g., bacteria such as E. coli, B. subtilis and S. aureus) on the surface of the structure and/or inhibits or substantially inhibits the growth of the microorganisms on the surface of the structure. The phrase “killing a substantial portion” includes killing at least about 70%, at least about 80%, at least about 90%, at least about 95%, or at least about 99% of the microorganism (e.g., bacteria) on the surface that the composition is disposed on, relative to structure that does not have the composition disposed thereon. The phrase “substantially inhibits the growth” includes reducing the growth of the microorganism (e.g., bacteria) by at least about 70%, at least about 80%, at least about 90%, at least about 95%, or at least about 99% of the microorganisms on the surface that the composition is disposed on, relative to a structure that does not have the composition disposed thereon.

As mentioned above, embodiments of the present disclosure are effective for the treatment of diseases affecting plants such as citrus plants and trees. In an embodiment, the composition can function as an antibacterial and/or antifungal, specifically, treating, substantially treating, preventing or substantially preventing, plant diseases such as citrus greening (HLB) and citrus canker diseases. The copper can be released from the composition so that it can act as an antibacterial and/or antifungal for a period of time (e.g., from application to days to months). The design of the composition facilitates uniform plant surface coverage or substantially uniform plant surface coverage. In an embodiment, the composition that is applied to plants can have a superior adherence property in various types of exposure to atmospheric conditions such as rain, wind, snow, and sunlight, such that it is not substantially removed over the time frame of the release of the copper. In an embodiment, the composition has a reduced phytotoxic effect or is non-phytotoxic to plants and reduced environmental stress due to minimal Cu content.

Embodiments of the present disclosure can applied on the time frames consistent with the release of the copper, and these time frames can include from the first day of application to about a week, about a month, about two months, about three months, about four months, about five months, about six months, about seven month, or about eight months.

### Examples

### Example

### Copper Silica Polymer Nanocomposite

### Materials and Methodology:

### Materials:

Copper Hydroxide (65% Metallic Cu)—Supplied by Gowan Company (GWN 10202)

Copper Hydroxide (61% Metallic Cu)—Supplied by Gowan Company (GWN 10316)

Hydrochloric Acid (conc HCL)—Fisher Scientific-Technical Grade CAS#7647-01-0

Sodium Hydroxide (1M & 4M NaOH)—Amresco ACS Grade CAS#1310-73-2

Tetraethylorthosilicate (TEOS)—Gelest Inc—CAS#78-10-4

Polyacrylamide (PAAm)(50% wt)—Aldrich—Catalog#434949, MW Avg 10,000, CAS#9003-05-8

Polyvinylpyrrolidone (PVP) (40 & 50% w/w)—Acros Organics—MW 8000, CAS #9003-39-8

Ethanol (ETOH) (95%)(190 Proof)—Decon Laboratories Inc, Ethyl Alcohol CAS#64-17-5

Deionized H₂O—Barnstead Nanopure Diamond

### Methodology:

### SG 0001 (GWN 10227)

2.895 g of Cu(OH)₂ (65% Metallic Cu) was added to 15 mL of EtOH along with 40 mL of deionized H₂O. This mixture was set to stir while slowly adding 6 mL of conc. HCL. An additional 303.8 mL of DI H₂O was added and left to stir for 30 mins to ensure all the Cu(OH)₂ was completely dissolved. After ensuring the Cu(OH)₂ was completely dissolved, 2.7 mL of TEOS was added dropwise and left to stir for 16-24 hrs. PAAm was then measured out and 112.5 mL was added to the stirring mixture and left for 16-24 hrs. At completion of stirring, 5 mL of 1M NaOH was used to raise the pH to 4.05. The mixture was left to stir for 6-12 hrs before use.
Cu(OH)₂=2.895 g, 65% Metallic Cu=1.88175 g,
(1.88175/485.4 ml)×1000=3.877 g/L Cu Specific Gravity=1.0222

### SG0005 (GWN 10308)

2.775 g of Cu(OH)₂ (65% Metallic Cu) was added to 15 mL of EtOH along with 40 mL of deionized H₂O. This mixture was set to stir while slowly adding 6 mL of conc. HCL. An additional 294.5 mL of DI H₂O was added and left to stir for 30 mins to ensure all the Cu(OH)₂ was completely dissolved. After ensuring the Cu(OH)₂ was completely dissolved, 2.7 mL of TEOS was added dropwise and left to stir for 16-24 hrs. PAAm was then measured out and 82.5 mL was added to the stirring mixture and left for 16-24 hrs. At completion of stirring, 17.8 mL of 1M NaOH was used to raise the pH to 4.08. The mixture was left to stir for 6-12 hrs before use.
Cu(OH)₂=2.775 g, 65% Metallic Cu=1.80375 g,
(1.80375/458.5 ml)×1000=3.934 g/L Cu Specific Gravity=1.0208

### SG0015 (GWN 10309)

2.85 g of Cu(OH)₂ (65% Metallic Cu) was added to 15 mL of EtOH along with 40 mL of deionized H₂O. This mixture was set to stir while slowly adding 6 mL of conc. HCL. An additional 291 mL of DI H₂O was added and left to stir for 30 mins to ensure all the Cu(OH)₂ was completely dissolved. After ensuring the Cu(OH)₂ was completely dissolved, 2.7 mL of TEOS was added dropwise and left to stir for 16-24 hrs. PVP (40% w/w) was then measured out and 97.5 mL was added to the stirring mixture and left for 16-24 hrs. At completion of stirring, 18 mL of 1M NaOH was used to raise the pH to 4.2. The mixture was left to stir for 6-12 hrs before use.
Cu(OH)₂=2.85 g, 65% Metallic Cu=1.8525 g,
(1.8525/470.2 ml)×1000=3.937 g/L Cu Specific Gravity=1.0086

### SG0017 (GWN 10310)

2.85 g of Cu(OH)₂ (65% Metallic Cu) was added to 15 mL of EtOH along with 40 mL of deionized H₂O. This mixture was set to stir while slowly adding 6 mL of conc. HCL. An additional 292.6 mL of DI H₂O was added and left to stir for 30 mins to ensure all the Cu(OH)₂ was completely dissolved. After ensuring the Cu(OH)₂ was completely dissolved, 2.7 mL of TEOS was added dropwise and left to stir for 16-24 hrs. PAAm was then measured out and 90 mL was added to the stirring mixture and left for 16-24 hrs. At completion of stirring, 16.8 mL of 1M NaOH was used to raise the pH to 4.08. The mixture was left to stir for 6-12 hrs before use.
Cu(OH)₂=2.85 g, 65% Metallic Cu=1.8525 g,
(1.8525/463.1 ml)×1000=4 g/L Cu Specific Gravity=1.0271

### SG0018 (GWN 10311)

2.895 g of Cu(OH)₂ (65% Metallic Cu) was added to 15 mL of EtOH along with 40 mL of deionized H₂O. This mixture was set to stir while slowly adding 6 mL of conc. HCL. An additional 296 mL of DI H₂O was added and left to stir for 30 mins to ensure all the Cu(OH)₂ was completely dissolved. After ensuring the Cu(OH)₂ was completely dissolved, 2.7 mL of TEOS was added dropwise and left to stir for 16-24 hrs. PVP (40% w/w) was then measured out and 135 mL was added to the stirring mixture and left for 16-24 hrs. At completion of stirring, 17 mL of 1M NaOH was used to raise the pH to 4.2. The mixture was left to stir for 6-12 hrs before use.
Cu(OH)₂=2.895 g, 65% Metallic Cu=1.88175 g,
(1.88175/511.7)×1000=3.677 g/L Cu Specific Gravity=1.0130

### SG0020 (GWN 10327)

10.416 g of Cu(OH)₂ (65% Metallic Cu) was added to 15 mL of EtOH along with 73 mL of deionized H₂O. This mixture was set to stir while slowly adding 18 mL of conc. HCL. After ensuring the Cu(OH)₂ was completely dissolved, 9.45 mL of TEOS was added dropwise and left to stir for 6-12 hrs. PAAm was then measured out and 393.75 mL was added to the stirring mixture and left for 16-24 hrs. At completion of stirring, 12 mL of 1M NaOH was used to raise the pH to 3.8. The mixture was left to stir for 6-12 hrs before use.
Cu(OH)₂=10.416 g, 65% Metallic Cu=6.7704 g,
(6.7704/521.2 ml)×1000=12.99 g/L Cu Specific Gravity=1.1541

### SG0021 (GWN 10328)

5.356 g of Cu(OH)₂ (65% Metallic Cu) was added to 15 mL of EtOH along with 34.6 mL of deionized H₂O. This mixture was set to stir while slowly adding 12 mL of conc. HCL. After ensuring the Cu(OH)₂ was completely dissolved, 4.99 mL of TEOS was added dropwise and left to stir for 6-12 hrs. PAAm was then measured out and 207.68 mL was added to the stirring mixture and left for 16-24 hrs. At completion of stirring, 36 mL of 1M NaOH was used to raise the pH to 3.75. The mixture was left to stir for 6-12 hrs before use.
Cu(OH)₂=5.356 g, 65% Metallic Cu=3.4814 g,
(3.4814/310.27)×1000=11.22 g/L Cu Specific Gravity=1.1445

### SG0022 (GWN 10332)

12.92 g of Cu(OH)₂ (61% Metallic Cu) was added to 15 mL of EtOH along with 22 mL of conc. HCL slowly. After ensuring the Cu(OH)₂ was completely dissolved, 11.1 mL of TEOS was added dropwise and left to stir for 6-12 hrs. PAAm was then measured out and 300 mL was added to the stirring mixture and left for 16-24 hrs. At completion of stirring, ˜71.78 mL of 1M NaOH was used to raise the pH to 4.33. The mixture was left to stir for 6-12 hrs before use.
Cu(OH)₂=12.92 g, 61% Metallic Cu=7.8812 g,
(7.8812/419.88)×1000=18.77 g/L Cu Specific Gravity=1.154

### SG0022M

75 mL of SG0022 (GWN 10332) (pH 4.33) was raised to pH 8.67 using 34 mL of 1M NaOH. The new Cu content was determined to be 12.92 g/L. The mixture was left to stir for 6-12 hrs before use.

### Specific Gravity=1.091

### SG0023

4.5 g of Cu(OH)₂ (61% Metallic Cu) was added to 10 mL of EtOH along with 10 mL of conc. HCL slowly. After ensuring the Cu(OH)₂ was completely dissolved, 3.7 mL of TEOS was added dropwise and left to stir for 6 hrs. PAAm was then measured out and 100 mL was added to the stirring mixture and left for 16-24 hrs. At completion of stirring, ˜27 mL of 4M NaOH was used to raise the pH to 8.82. The mixture was left to stir for 6-12 hrs before use.
Cu(OH)₂=4.5 g, 61% Metallic Cu=2.745 g,
(2.745/151 ml)×1000=18.18 g/L Cu Specific Gravity=1.145

### SG0024

4.5 g of Cu(OH)₂ (61% Metallic Cu) was added to 14 mL of EtOH along with 8 mL of conc. HCL slowly. After ensuring the Cu(OH)₂ was completely dissolved, 3.7 mL of TEOS was added dropwise and left to stir for 6 hrs. PVP (50% w/w) was then measured out and 100 mL was added to the stirring mixture and left for 16-24 hrs. At completion of stirring, ˜19.4 mL of 4M NaOH was used to raise the pH to 8.38. The mixture was left to stir for 6-12 hrs before use.
Cu(OH)₂=4.5 g, 61% Metallic Cu=2.745 g,
(2.745/145.1)×1000=18.92 g/L Cu Specific Gravity=1.094
   Table 1 is a summary of the Nanoformulation Compositions.

| Formu- | Metallic | | PVP | PAAm | | |
|---|---|---|---|---|---|---|
| lation | Cu | TEOS | (40/50% wt) | (50% wt) | | Specific |
| Code | (g/L) | (mL) | (mL) | (mL) | pH | Gravity |
| SG0001 | 3.877 | 2.7 | NA | 112.5 | 4.05 | 1.0222 |
| SG0005 | 3.934 | 2.7 | NA | 82.5 | 4.08 | 1.0208 |
| SG0015 | 3.937 | 2.7 | 97.5 | NA | 4.2 | 1.0086 |
| SG0017 | 4.0 | 2.7 | NA | 90 | 4.08 | 1.0271 |
| SG0018 | 3.677 | 2.7 | 135 | NA | 4.2 | 1.0130 |
| SG0020 | 12.99 | 9.45 | NA | 393.75 | 3.8 | 1.1541 |
| SG0021 | 11.22 | 4.99 | NA | 207.68 | 3.75 | 1.1445 |
| SG0022 | 18.77 | 11.1 | NA | 300 | 4.33 | 1.1540 |
| SG0022M | 12.92 | 11.1 | NA | 300 | 8.67 | 1.091 |
| SG0023 | 18.18 | 3.7 | NA | 100 | 8.82 | 1.145 |
| SG0024 | 18.92 | 3.7 | 100 | NA | 8.38 | 1.094 |

### Copper Silica Polymer Nanocomposite:

### Characterization:

Scanning Electron Microscopy (SEM) and High-Resolution Transmission Electron Microscopy (HRTEM) was conducted to observe the morphology, crystallinity and confirm the elemental composition of the 2 nanoformulations (SG0023 and SG0024). SEM was conducted on a Zeiss Ultra-55 FEG SEM using mica wafers. The TEM was conducted on a FEI Tecnai F30 using carbon filmed gold grids.

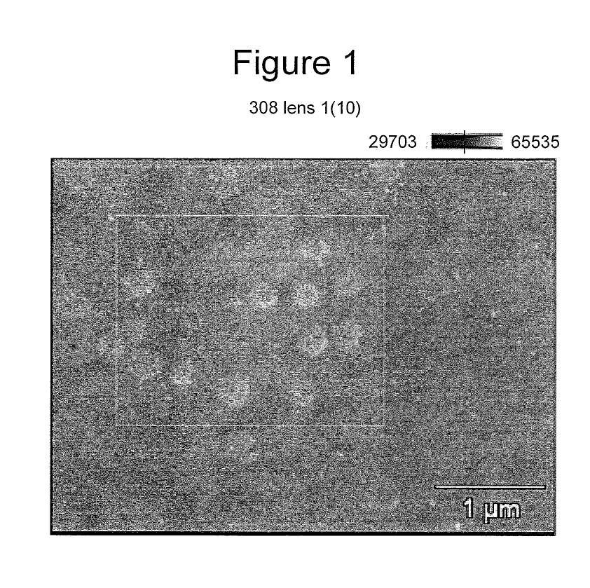

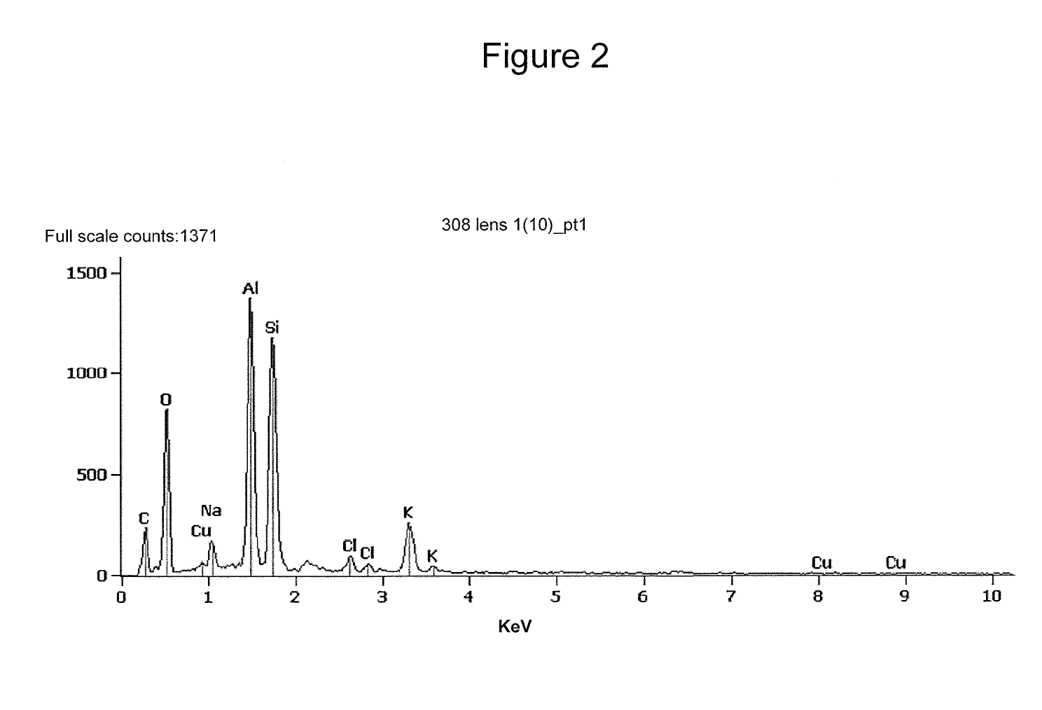

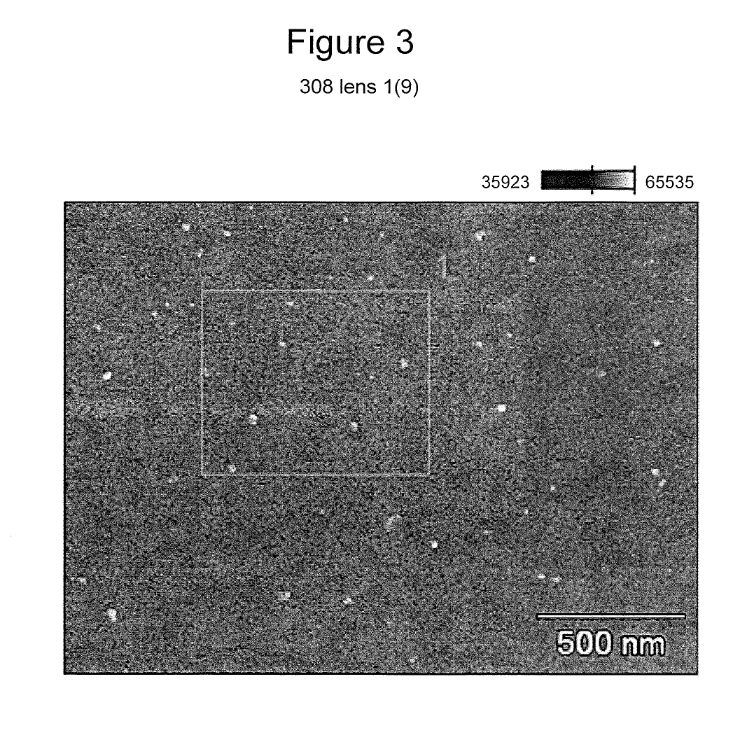

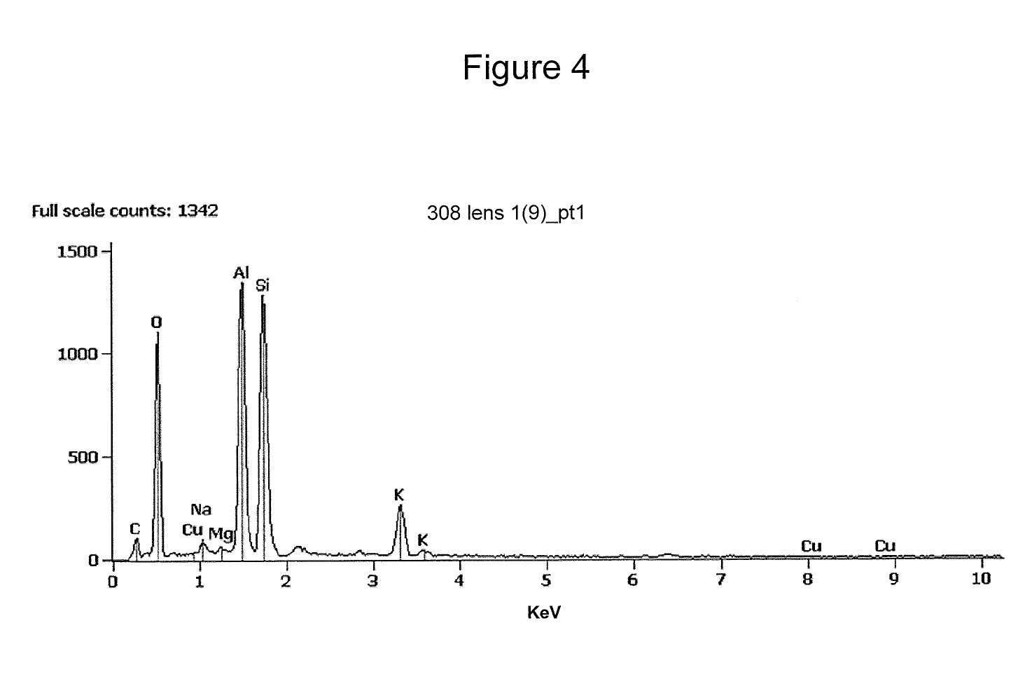

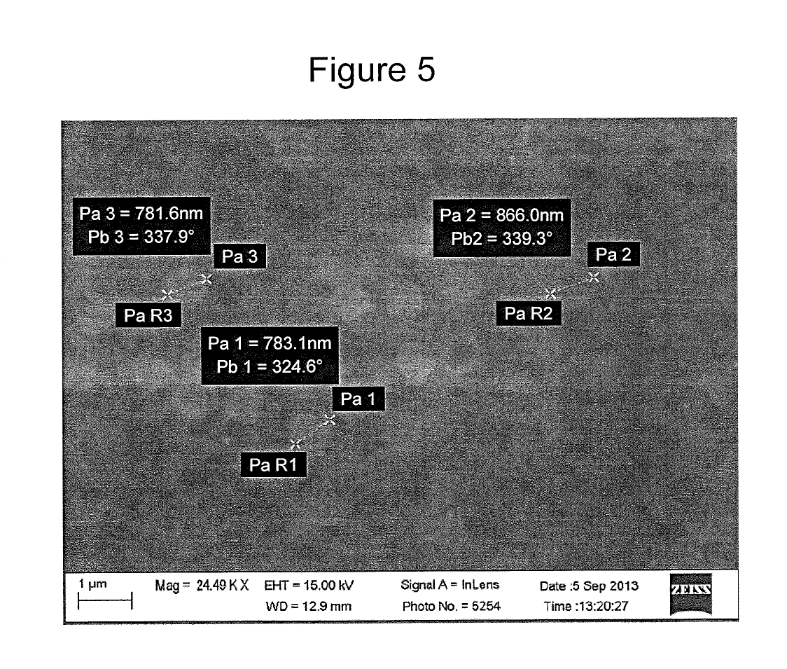

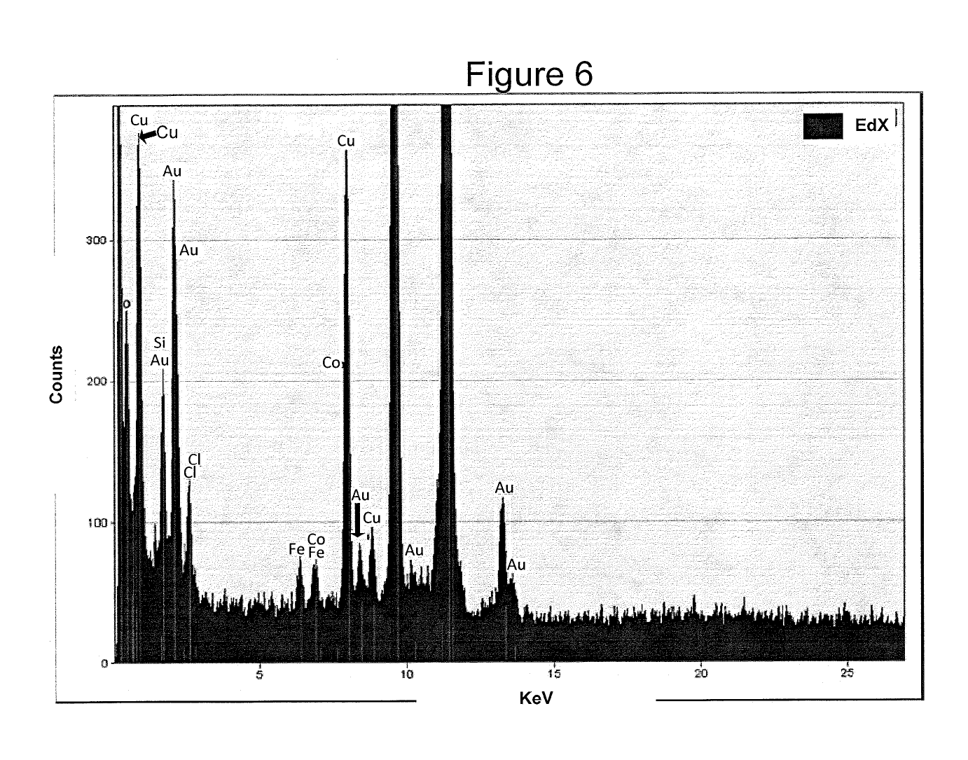

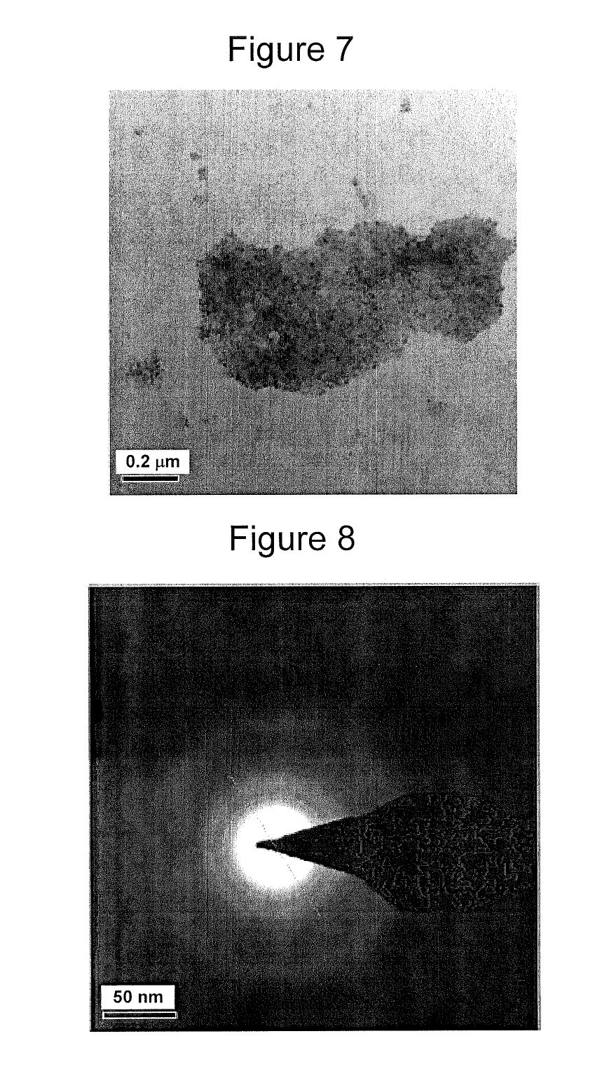

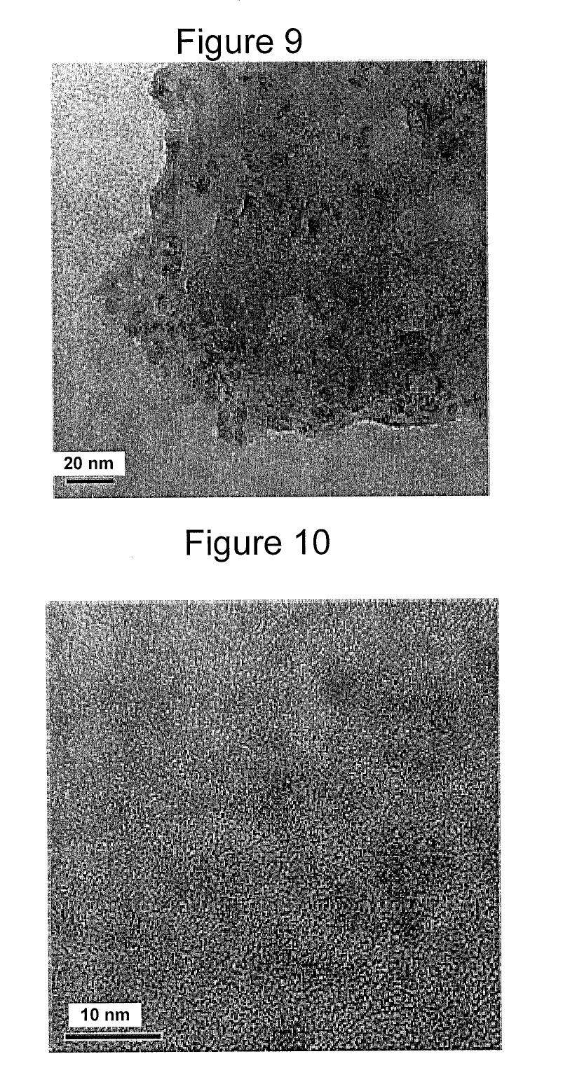

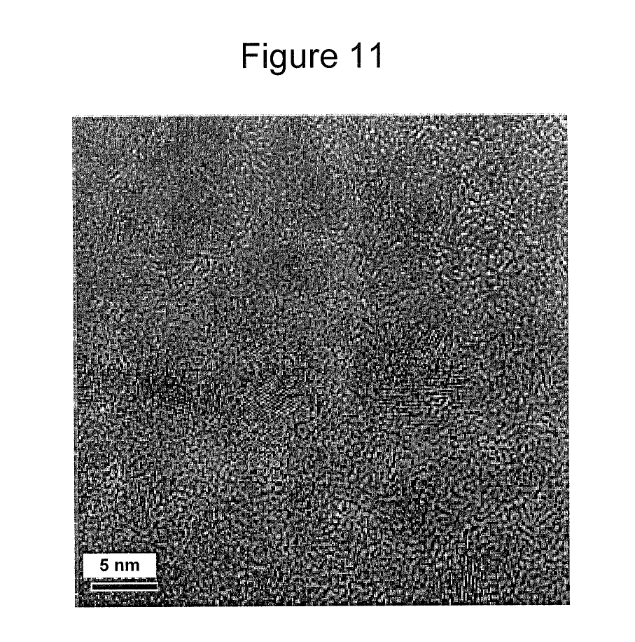

In the SG0023 formulation, the elemental composition was confirmed using Energy Dispersive Spectroscopy (EDS) while doing SEM AND HRTEM. The EDS confirmed the presence of our sample by identifying the Cu and Si in the material (FIGS. 2, 4, and 6). SEM images showed spherical clusters within the larger silica matrix, with aggregates ranging from 50-600 nm (FIGS. 1, 3, and 5). HRTEM exhibited a well dispersed material with areas of light and dark contrast of electron rich material (FIGS. 7 and 9). The crystallinity of the Cu materials were confirmed using Selected Area Electron Diffraction (SAED) (FIG. 8). Crystallites of Cu were clearly visible at high magnification. Determination of the lattice revealed spacing of 2.76 Å, 2.27 Å, 3.03 Å, 1.78 Å and 2.54 Å. These values correspond with CuO, CuO, Cu₂O, Cu and CuO respectively (FIGS. 10 and 11).

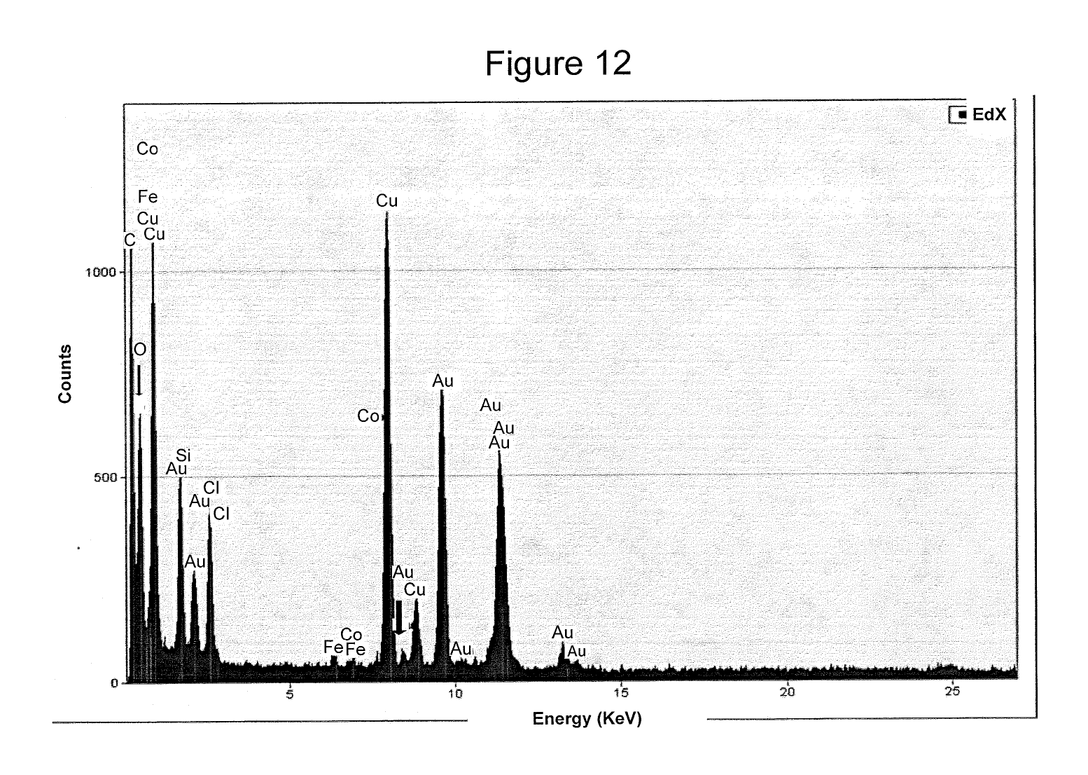

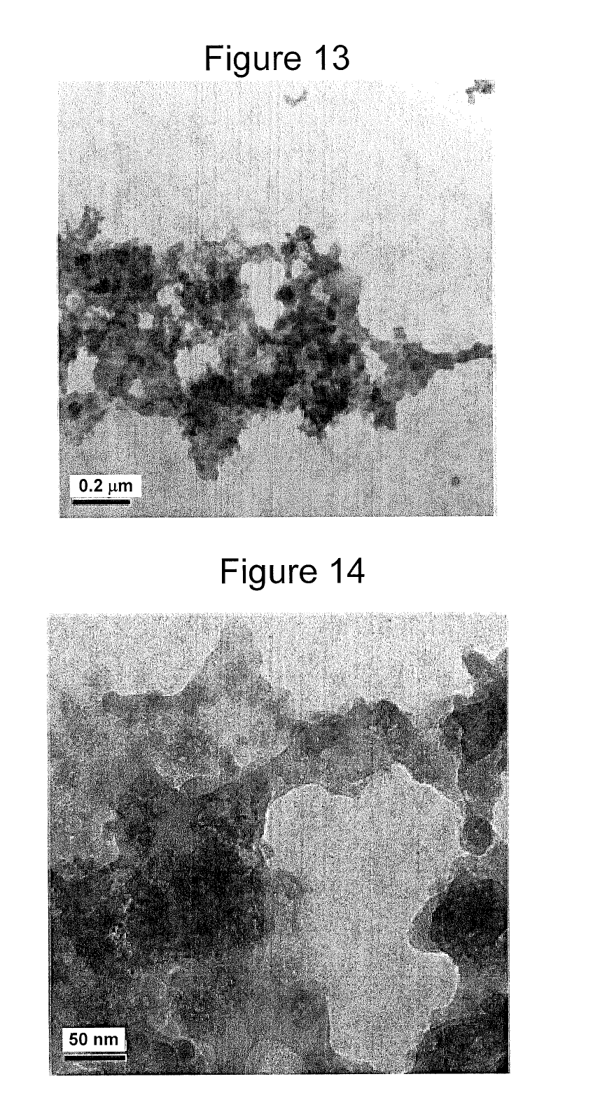

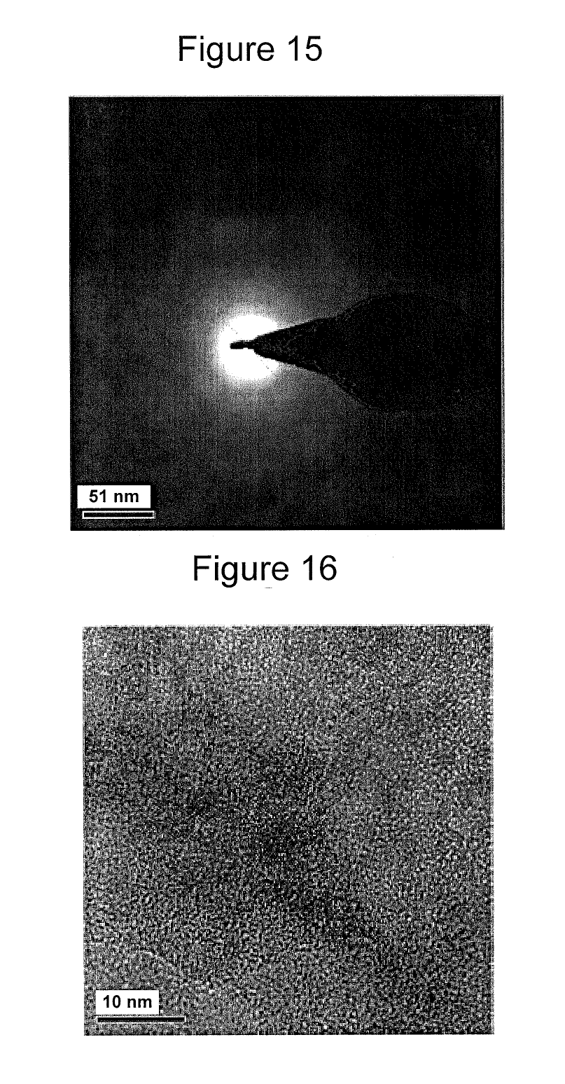

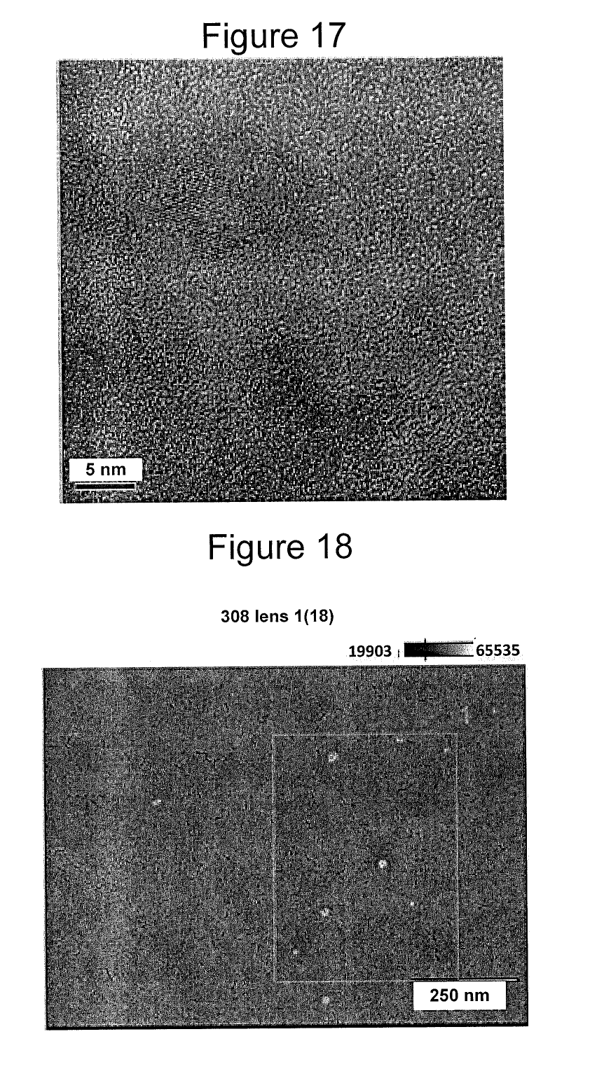

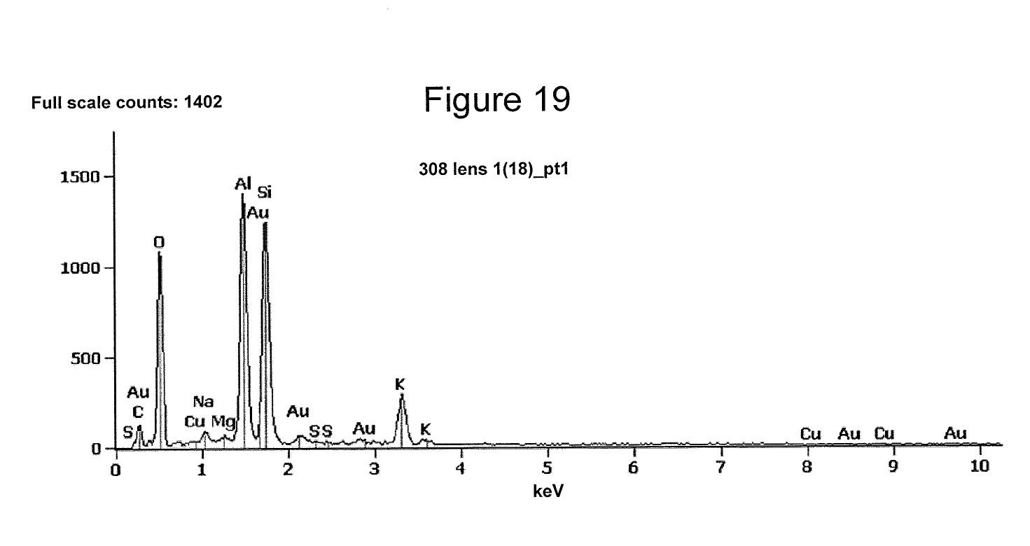

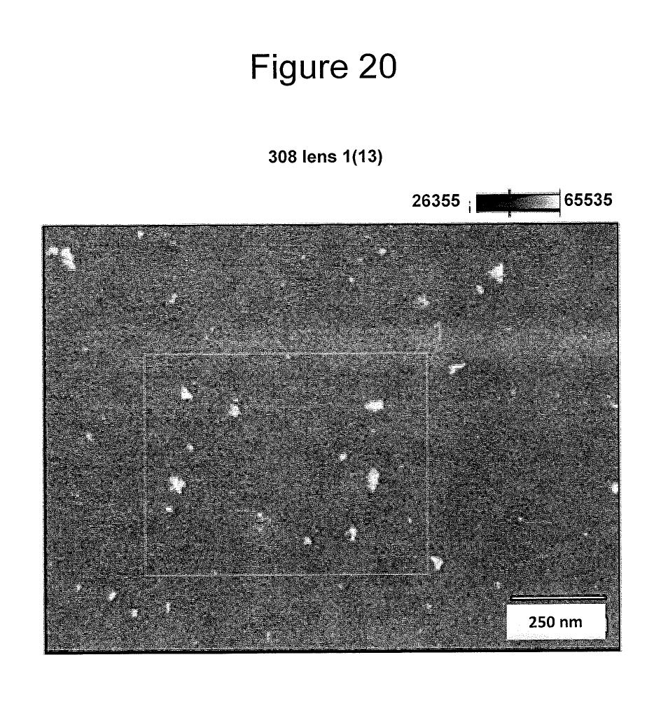

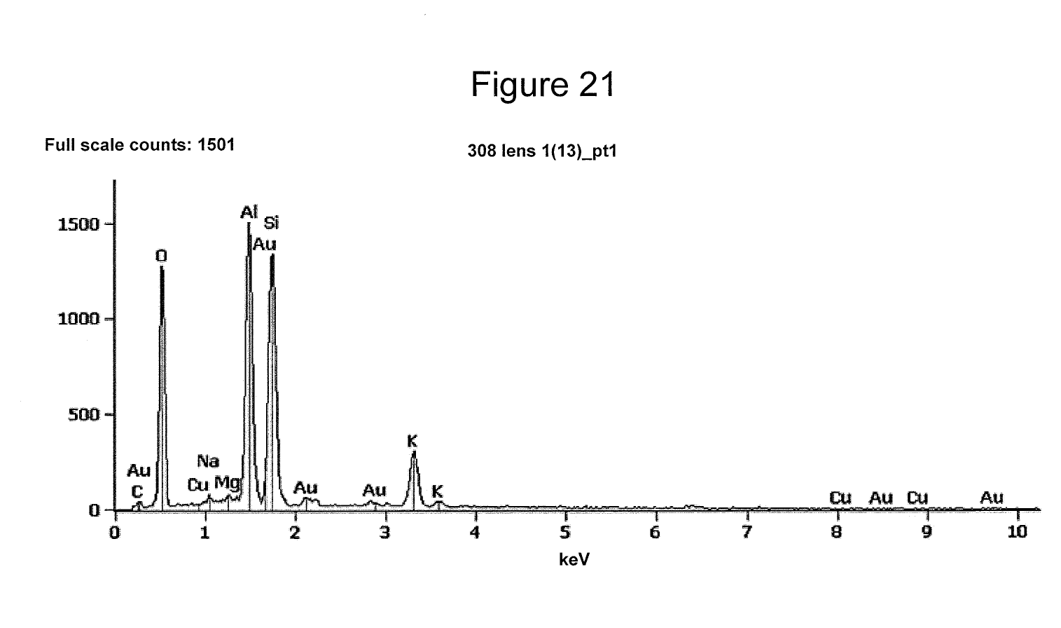

In the SG0024 formulation, the elemental composition was confirmed using Energy Dispersive Spectroscopy (EDS) while doing SEM AND HRTEM. The EDS confirmed the presence of our sample by identifying the Cu and Si in the material (FIGS. 12, 19, and 21). SEM images showed spherical clusters within the larger silica matrix, with aggregates ranging from 50-300 nm (FIGS. 18 and 20). HRTEM exhibited a well dispersed material with areas of light and dark contrast of electron rich material (FIGS. 13 and 14). The crystallinity of the Cu materials were confirmed using Selected Area Electron Diffraction (SAED) (FIG. 15). Crystallites of Cu were clearly visible at high magnification. Determination of the lattice revealed spacing of 2.75 Å, 2.45 Å and 2.26 Å. These values correspond with CuO, Cu₂O and CuO respectively (FIGS. 16 and 17).

### Phytotoxicity Studies:

Phytotoxicity studies were conducted to observe plant injury on exposure to our nanoformulations. Studies were conducted on Vinca sp obtained from the local Home Depot and kept in a mini-greenhouse under conditions ≧80 F temperature and ≧40% humidity. Plants were obtained and allowed to acclimatize for 24 hrs before formula application. Nanoformulations were applied at specific Cu concentrations between 6 and 8 am before temperatures rose too high. Plants were observed for tissue damage at 24, 48 and 72 hr time points.

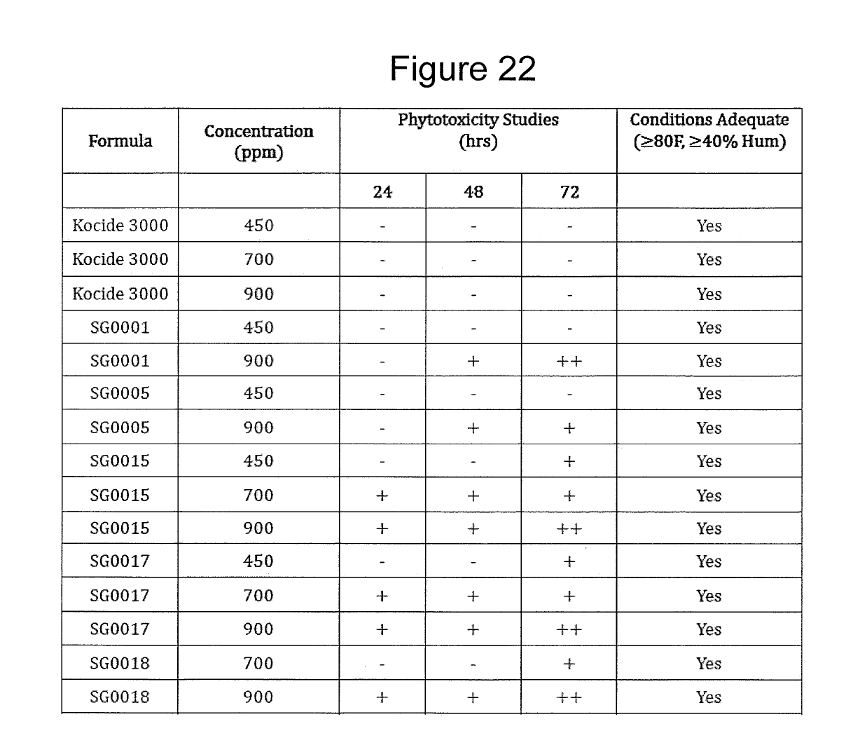

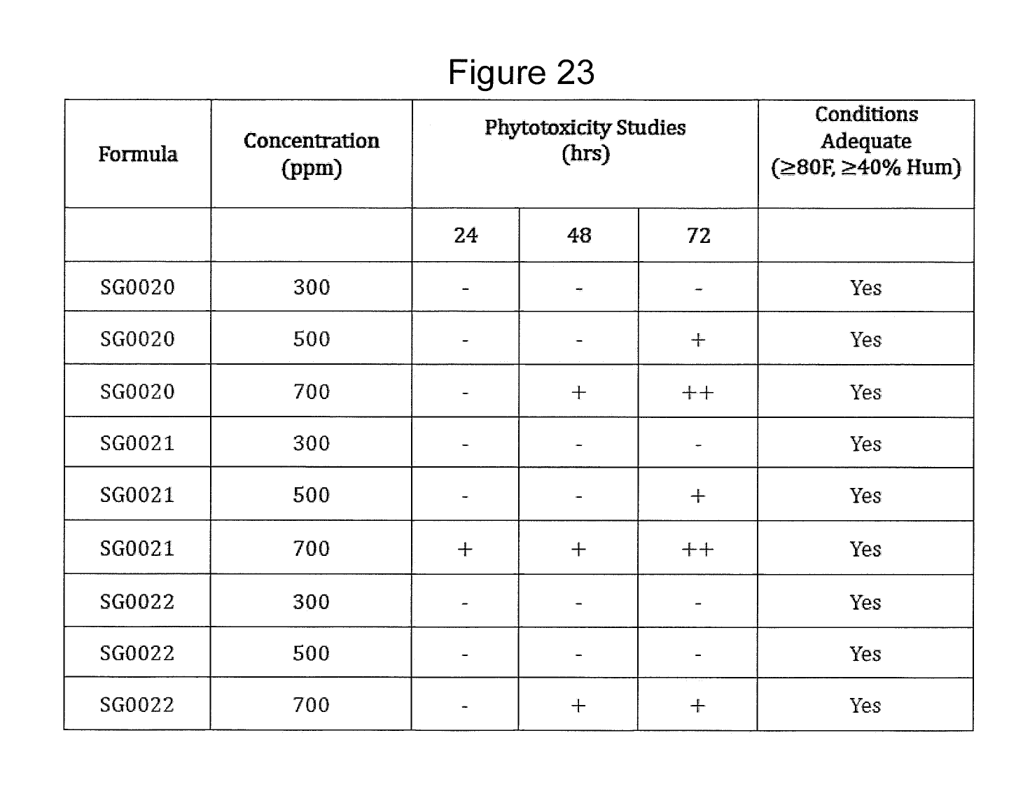

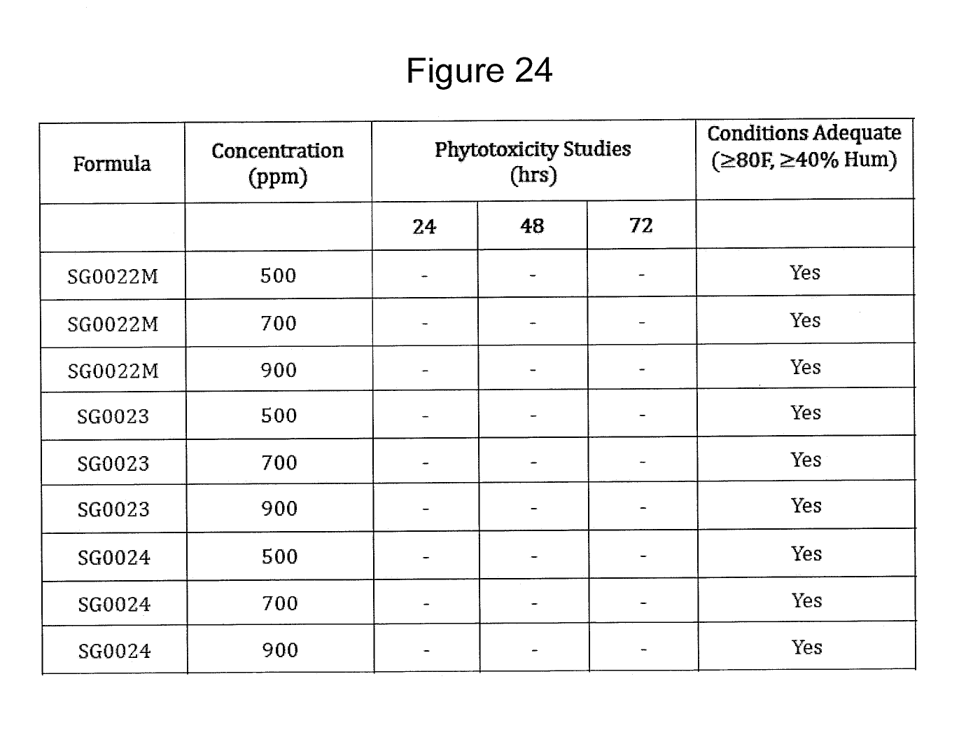

It was seen that SG0001, SG0005, SG0015, SG0017, SG0018, SG0020, SG0021 and SG0022 (FIGS. 22 and 23) caused moderate to high levels of plant tissue damage. SG0022M, SG0023, SG0024 and Kocide 3000 (FIGS. 22 and 24) exhibited no plant tissue damage at any Cu concentrations after 72 hrs. The reason for no toxicity was due to higher pHs in SG0022M, SG0023, SG0024 and Kocide 3000. Higher pHs lead to oxidation of Cu ions into less soluble Cu oxide and hydroxide.

### Antimicrobial Studies:

Antimicrobial studies were conducted to ascertain the effectiveness of synthesized nanoformulations in comparison to the Kocide 3000 control. Studies conducted were growth inhibition assays using Muller Hinton 2 (MH2) broth and determination of the Minimum Inhibitory Concentration (MIC) following the guidelines of the Clinical and Laboratory Standards Institute (CLSI). Studies were conducted against gram negative E. coli sp.

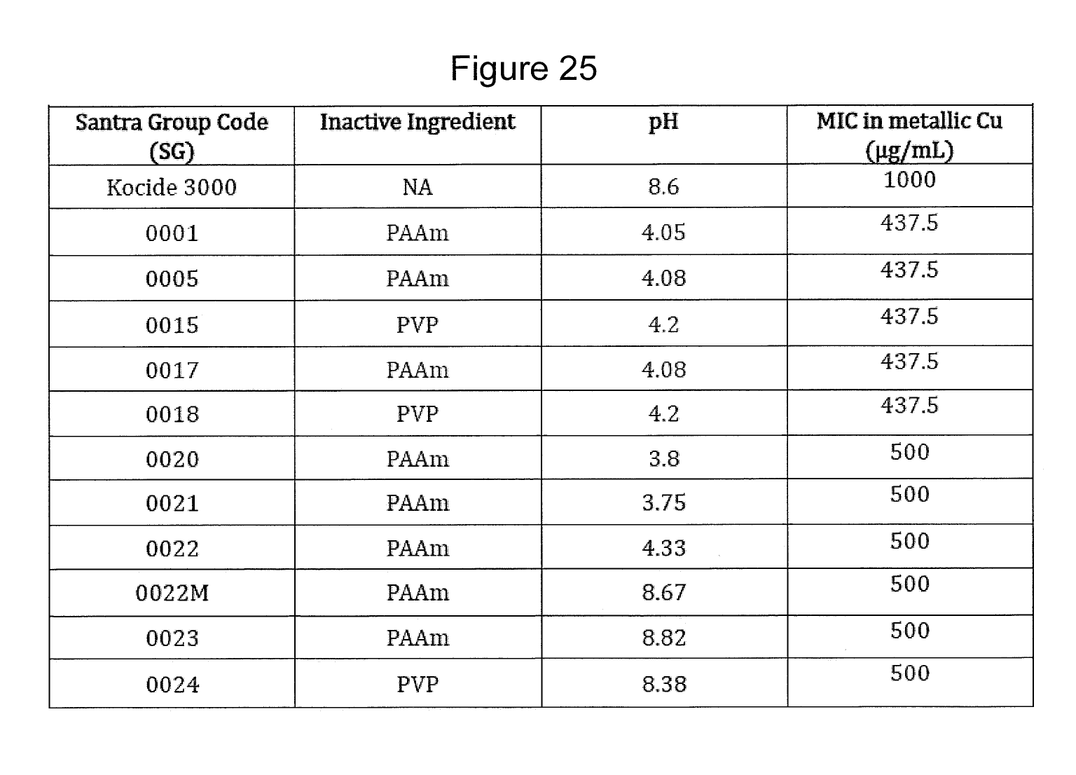

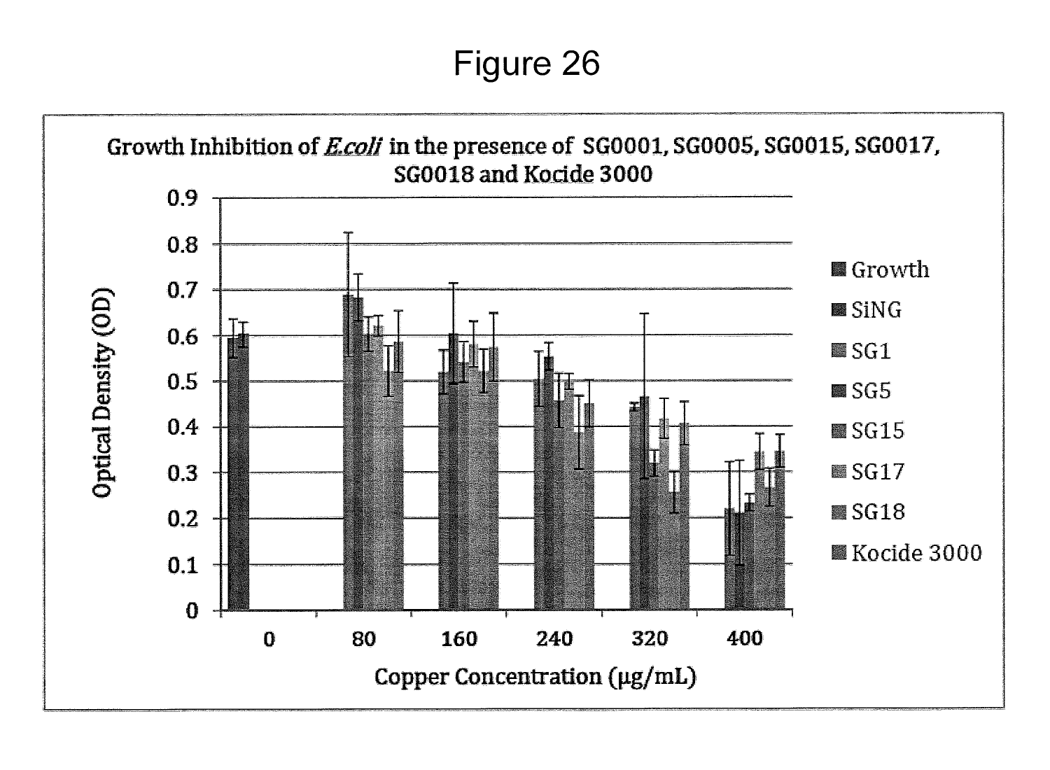

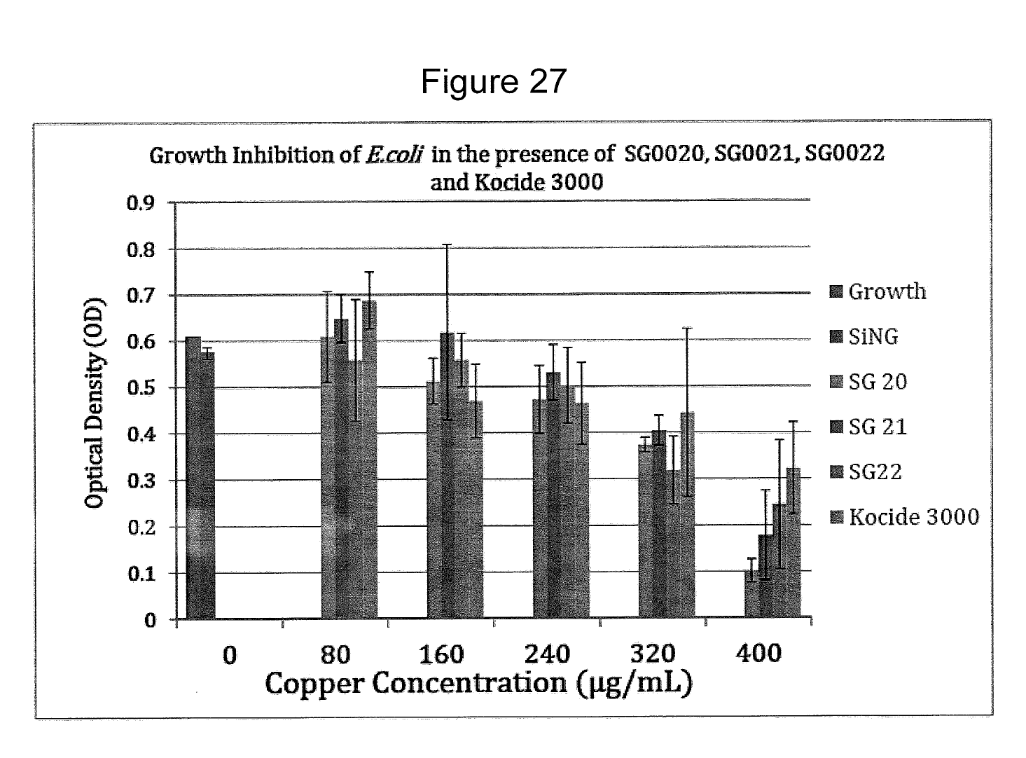

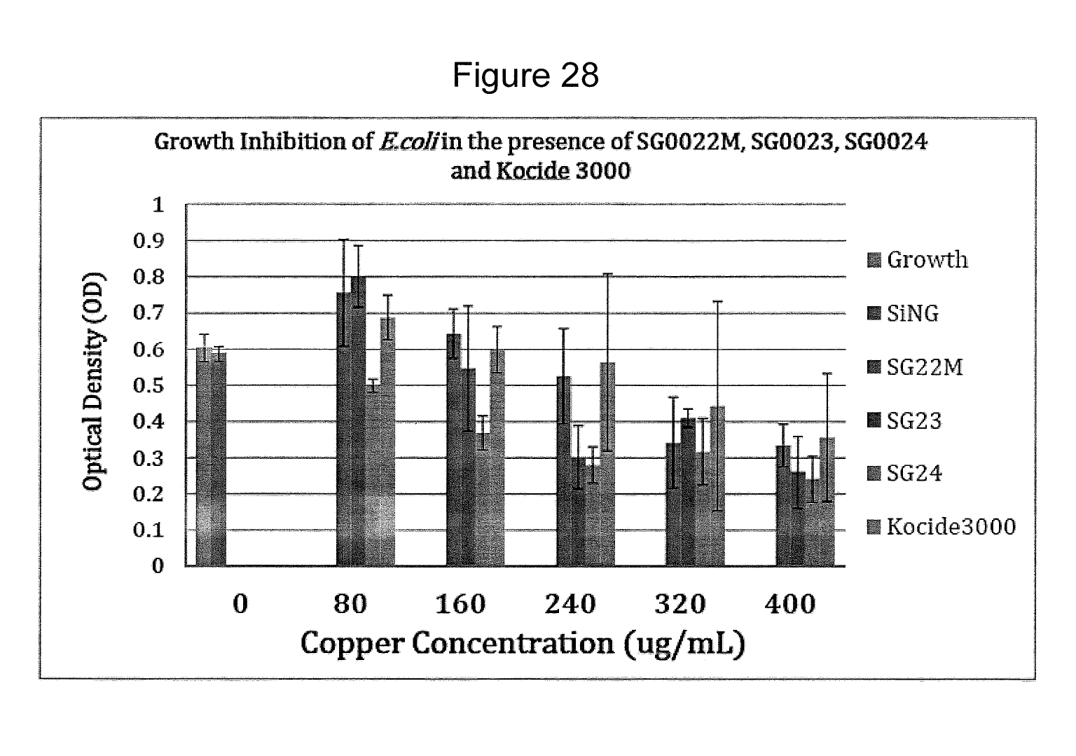

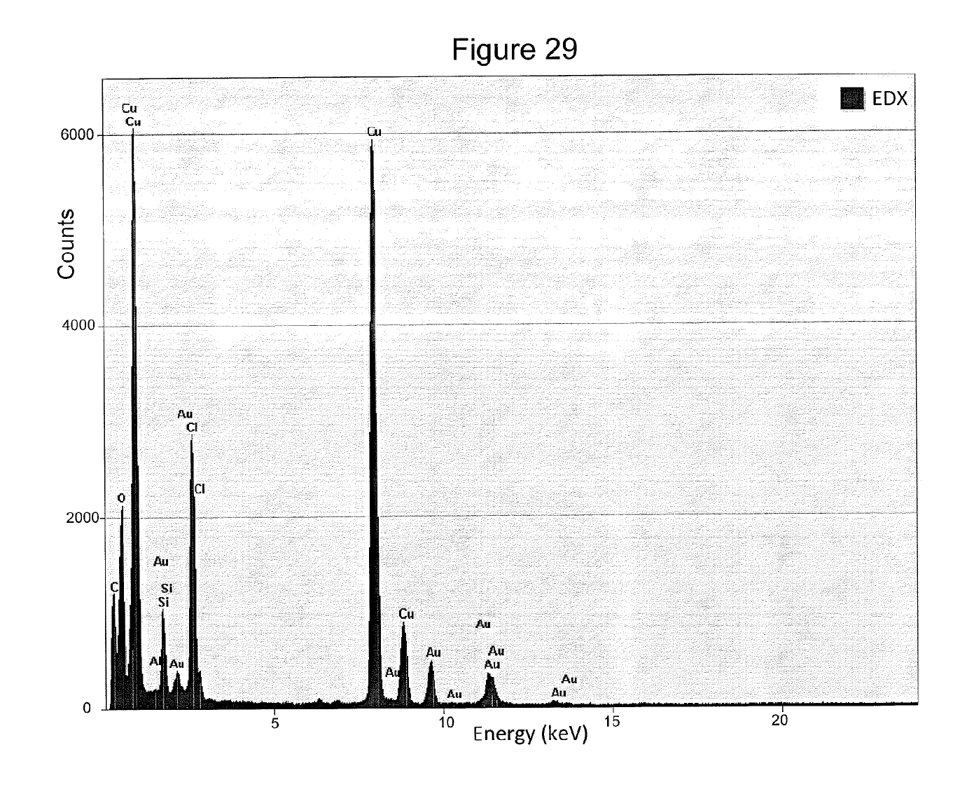

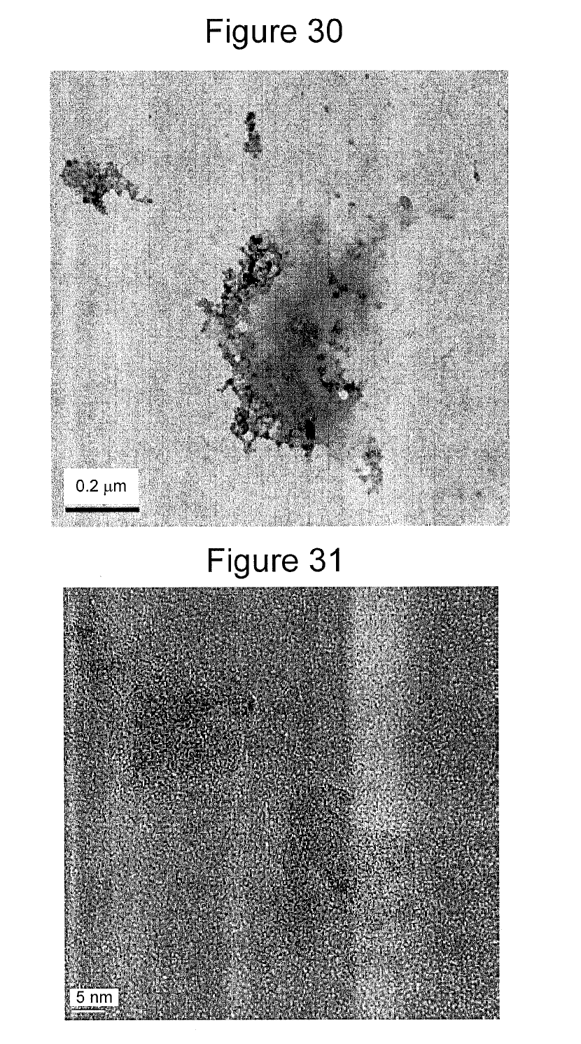

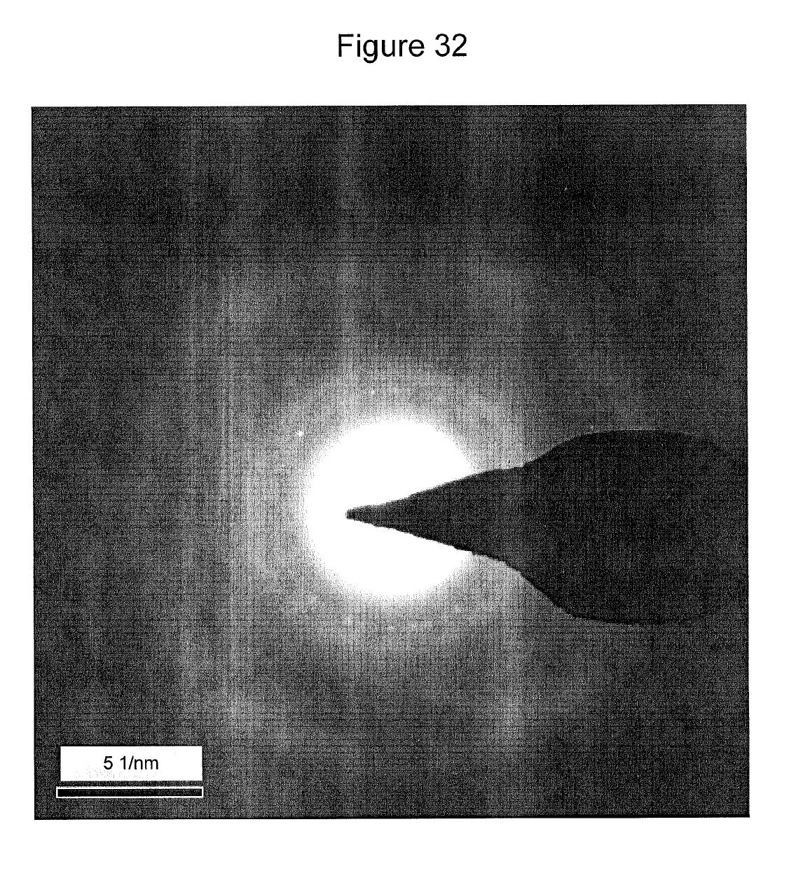

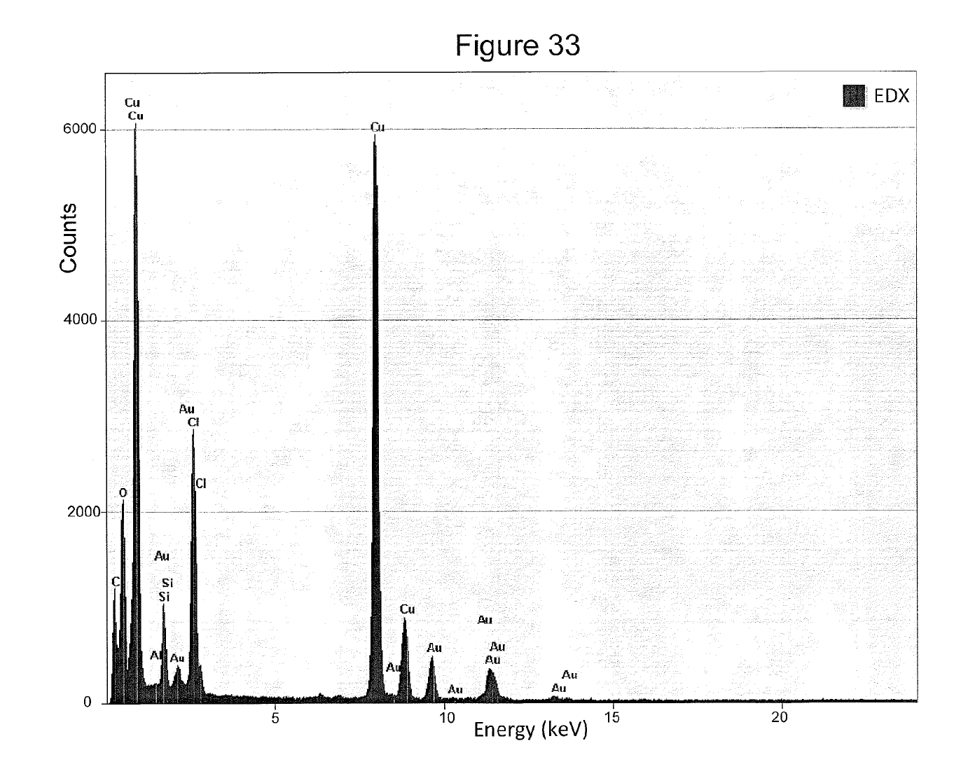

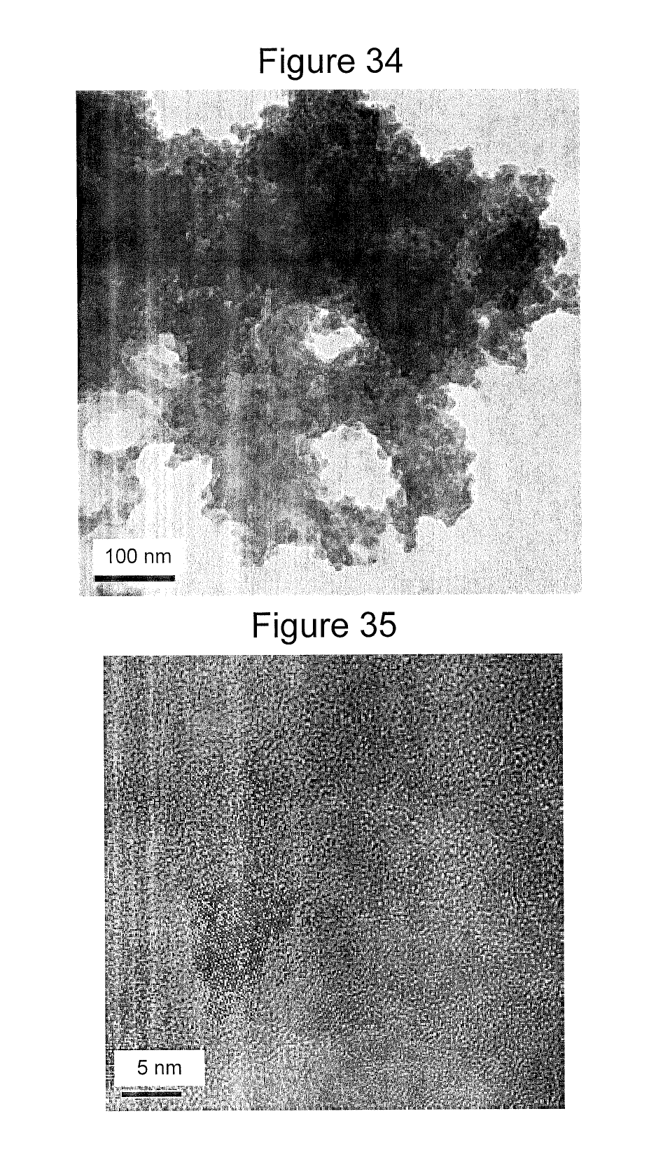

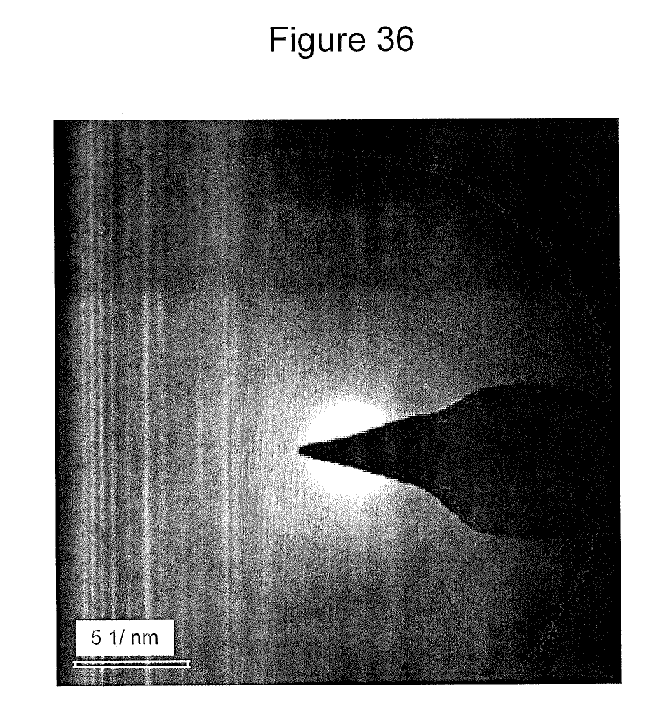

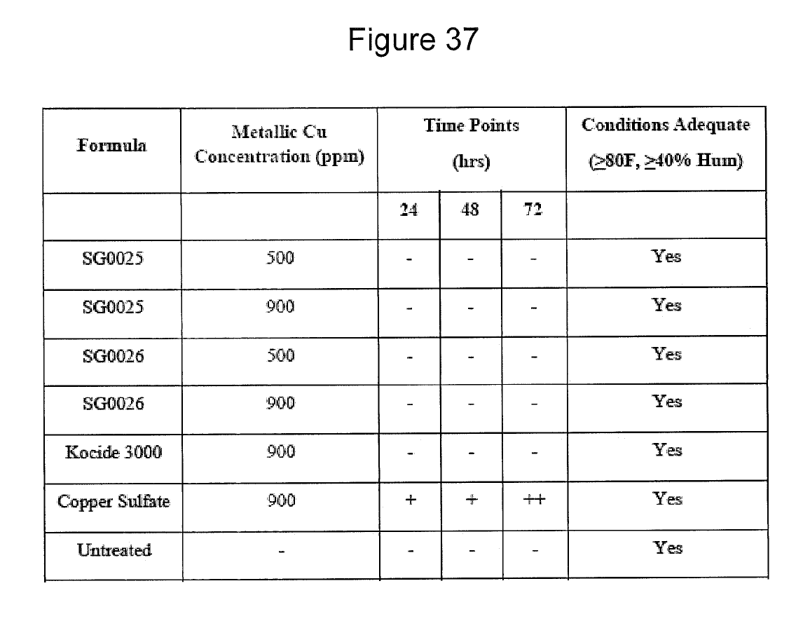

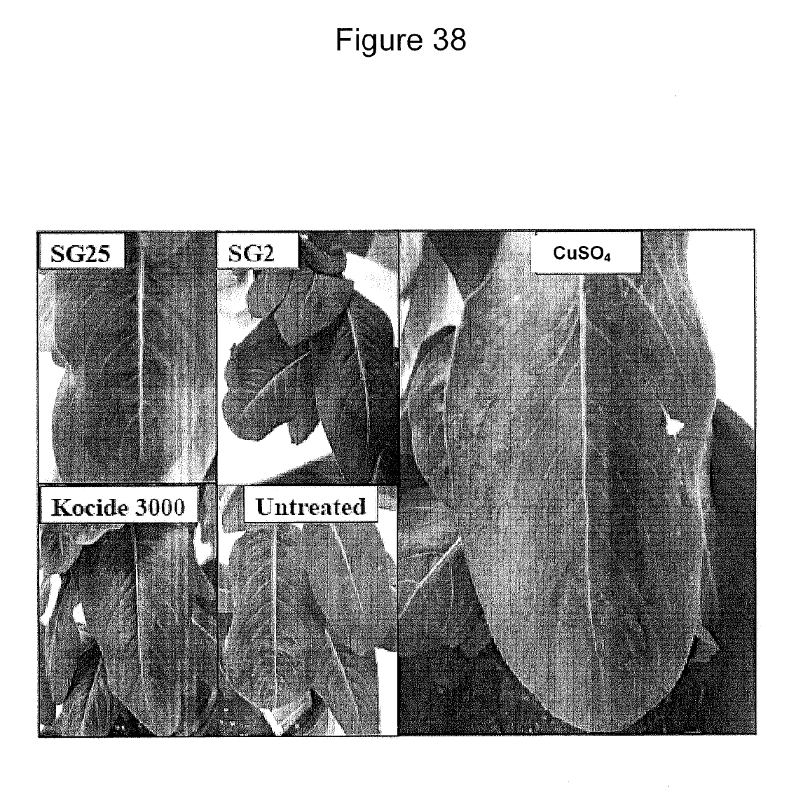

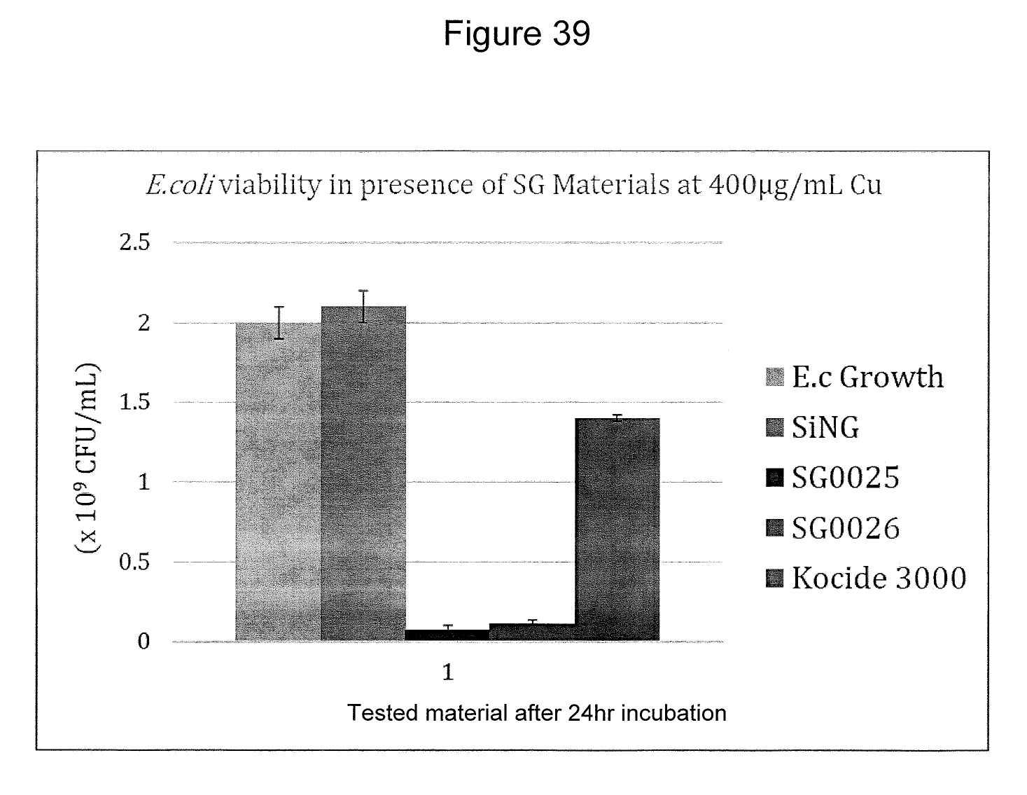

Growth inhibition studies showed reduced bacterial growth as Cu concentration increased. Results indicated improved antimicrobial efficacy in Cu nanoformulations in relation to the Kocide 3000 control (FIGS. 26, 27, and 28). The MIC of Cu nanoformulations was found to be 437.5 μg/mL for SG0001, SG0005, SG0015, SG0017 and SG0018. The MIC for SG0020, SG0021, SG0022, SG0022M, SG0023 and SG0024 was 500 μg/mL while Kocide 3000 had a value of 1000 μg/mL (FIG. 25). This reinforces the higher antimicrobial efficacy of our Cu nanoformulations.

### Synthesis of SG0025 and SG0026

Copper Hydroxide, Cu(OH)₂, (61% Metallic Cu)—Supplied by Gowan Company (GWN 10316)

Hydrochloric Acid (conc HCL)—Fisher Scientific-Technical Grade CAS#7647-01-0

Sodium Hydroxide (6M NaOH)—Fisher Scientific CAS#1310-73-2

Tetraethylorthosilicate (TEOS)—Gelest Inc—CAS#78-10-4

Polyacrylamide (PAAm)(50% wt)—CarboMer, Inc. Cat#600-200, MW Avg 10,000, CAS#9003-05-8

Polyvinylpyrrolidone (PVP) (50% w/w)—Acros Organics—MW 8000, CAS #9003-39-8

Ethanol (ETOH) (95%)(190 Proof)—Decon Laboratories Inc, Ethyl Alcohol CAS#64-17-5

Deionized H₂O—Barnstead Nanopure Diamond

### 1) Code: SG 0025

Cu Source=Copper Hydroxide
Inactive Ingredient=Polyacrylamide (PAAm)
Metallic Cu Content=35.3 g/L
Specific Gravity=1.148

### 2) Code: SG 0026

Cu Source=Copper Hydroxide
Inactive Ingredient=Polyvinylpyrrolidone (PVP)
Metallic Cu Content=36.09 g/L
Specific Gravity=1.101

### Synthesis of ˜500 mL of Material

### SG0025

30 g of Cu(OH)₂ (61% Metallic Cu) was added to 40 mL of EtOH and 41 mL of H₂O along with 50 mL of conc. HCL slowly. After ensuring the Cu(OH)₂ was completely dissolved (˜1 hr), 23 mL of TEOS was added slowly and left to stir for 4-6 hrs. PAAm was then measured out and 250 mL was added to the stirring mixture and left for 16-20 hrs. At completion of stirring, ˜105 mL of 4M NaOH was used to raise the pH to ˜7-8. The mixture was left to stir for 6-12 hrs before use.
Cu(OH)₂=30 g, 61% Metallic Cu=18.3 g,
Volume of Cu(OH)₂ added, Density=3.368 g/cm³, D=M/V, therefore V=8.91 mL
Total Volume=517.9 mL
(18.3/517.9 ml)×1000=35.3 g/L Cu Specific Gravity=1.148

### SG0026

30 g of Cu(OH)₂ (61% Metallic Cu) was added to 40 mL of EtOH and 20 mL of H₂O along with 50 mL of conc. HCL slowly. After ensuring the Cu(OH)₂ was completely dissolved (˜1 hr), 23 mL of TEOS was added slowly and left to stir for 4-6 hrs. PVP was then measured out and 250 mL was added to the stirring mixture and left for 16-20 hrs. At completion of stirring, ˜115 mL of 4M NaOH was used to raise the pH to ˜7-8. The mixture was left to stir for 6-12 hrs before use.
Cu(OH)₂=30 g, 61% Metallic Cu=18.3 g,
Volume of Cu(OH)₂ added, Density=3.368 g/cm³, D=M/V, therefore V=8.91 mL
Total Volume=507 mL
(18.3/507 ml)×1000=36.09 g/L Cu Specific Gravity=1.101

### Alternative SG0025-S Synthesis Protocol

### Chemicals/Solvents

1. Gowan Copper Hydroxide, Cu(OH)₂, (60.9% Metallic Cu)—GWN 10316
2. Hydrochloric Acid (Conc. HCl)—Fisher Scientific-Technical Grade CAS#7647-01-0
3. Sodium Hydroxide (NaOH)—Fisher Scientific CAS#1310-73-2
4. Sodium Silicate (37%)—Fisher Scientific (Cat. #525566A; CAS#1344-09-8)
5. Polyacrylamide (PAAm; 50% w/w)—CarboMer, Inc.
   Cat#6-00200, MW Avg 10,000, CAS#9003-05-8
6. Deionized (DI) water—Barnstead Nanopure Diamond purifier

### Synthesis of SG0025-S

Preparation of SG0025-S formulation was carried out in a 250 mL glass conical flask at room temperature and under continuous magnetic stirring (200 rpm) conditions.
Add 8.0 g of Cu(OH)₂ to 25 mL DI water and begin mixing.
Then pour slowly 14 mL Conc. HCl into the solvent mixture to fully dissolve Cu(OH)
In a separate flask, add 6 mL of sodium silicate to 60 mL of polyacrylamide solution and stir vigorously.
Stir both flasks for 25 mins.
Add the polyacrylamide-sodium silicate mixture to the dissolved Cu(OH)₂ and stir for an additional 30 mins.
Then add 30 mL of 4M NaOH to raise the pH to ˜8.
Stir for at least 2 hrs to ensure proper mixing and pH stabilization.
Cu(OH)₂ density=3.368 g/mol, therefore 8 g has a volume of 2.375 cm³; Total Volume=137.375 mL; Metallic Cu content=35, 465 μg/mL

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. In an embodiment, the term “about” can include traditional rounding according to measurement techniques and the numerical value. In addition, the phrase “about ‘x’ to ‘y’” includes “about ‘x’ to about ‘y’”.

Many variations and modifications may be made to the above-described embodiments. All such modifications and variations are intended to be included herein within the scope of this disclosure and protected by the following claims.

Therefore, at least the following is claimed:

1. A composition, comprising:
a copper/silica nanocomposite having a silica gel matrix that includes copper from one or more of copper nanoparticles and copper ions, and
a polymer selected from the group consisting of: polyvinylpyrrolidone, polyacrylamide, polylactic acid, polyglycolic acid, starch, a quaternary ammonium compound, and a combination thereof.

2. The composition of claim 1, wherein the ratio of copper/silica nanocomposite to polymer is about 0.1:1 to 3:1.

3. The composition of claim 1, wherein the composition is transparent or translucent to visible light.

4. The composition of claim 1, wherein the composition has an antimicrobial characteristic, and has a lower phytotoxicity than another composition including the copper/silica nanocomposite but not the polymer.

5. The composition of claim 1, wherein the copper is about 1 microgram (μg)/mL to 20 milligram (mg)/mL of the copper/silica-polymer nanocomposite.

6. The composition of claim 1, wherein the copper nanoparticles have a diameter of about 5 to 20 nm.

7. The composition of claim 1, wherein the polymer is poly(lactic-co-glycolic acid) (PLGA).

8. The composition of claim 1, wherein the polymer is selected from the group consisting of: polyvinylpyrrolidone or polyacrylamide.

9. A method of making a composition, comprising:
mixing a silica precursor compound, a copper precursor compound, and water;
adjusting the pH to less than about 7 and holding for about 12 to 36 hours;
forming a copper/silica nanocomposite having a silica gel matrix that includes copper from one or more of copper nanoparticles and copper ions;
mixing a polymer with the mixture while having an acidic pH for about 12 to 36 hours, wherein the polymer is selected from the group consisting of: a polymer selected from the group consisting of: polyvinylpyrrolidone, polyacrylamide, polylactic acid, polyglycolic acid, starch, a quaternary ammonium compound, and a combination thereof;
raising the pH to about 4 to 10; and
forming the composition.

10. The method of claim 9, wherein the weight ratio of the silica precursor compound to the copper precursor compound can be about 0.1:1 to 3:1.

11. The method of claim 9, wherein the ratio of copper/silica nanocomposite to polymer is about 0.1:1 to 3:1.

12. The method of claim 9, wherein the copper nanoparticle precursor compound is selected from: copper hydroxide, cupric chloride, cuprous chloride, cupric oxide, cuprous oxide, copper sulfate, copper nitrate, and a combination thereof.

13. The method of claim 9, wherein the silane precursor compound is selected from the group consisting of: alkyl silane, tetraethoxysilane (TEOS), tetramethoxysilane (TMOS), sodium silicate, a silane precursor that can produce silicic acid or silicic acid like intermediates, and a combination thereof.

14. The method of claim 9, wherein the polymer is poly(lactic-co-glycolic acid) (PLGA).

15. The method of claim 9, wherein the polymer is selected from the group consisting of: polyvinylpyrrolidone or polyacrylamide.

16. A method, comprising:
disposing a composition on a surface, wherein the composition has a copper/silica nanocomposite having a silica gel matrix that includes copper from one or more of copper nanoparticles and copper ions, and a polymer selected from the group consisting of: a polymer selected from the group consisting of: polyvinylpyrrolidone, polyacrylamide, polylactic acid, polyglycolic acid, starch, a quaternary ammonium compound, and a combination thereof; and
killing a substantial portion of a microorganism or inhibiting or substantially inhibiting the growth of the microorganisms on the surface of a structure or that come into contact with the surface of the structure.

17. The method of claim 16, wherein the microorganism is a bacterium.

18. The method of claim 16, wherein the microorganism selected from the group consisting of: E. coli, B. subtilis, Xanthomonas sp, Candidatus Liberibacter spp, and S. aureus.

19. The method of claim 16, wherein the structure is a plant or tree.

20. The method of claim 19, wherein disposing includes forming a film of the composition.

21. The method of claim 16, wherein disposing includes forming a uniform plant surface coverage.

22. The method of claim 16, wherein disposing includes forming a substantially uniform plant surface coverage.

23. The method of claim 16, wherein the polymer is poly(lactic-co-glycolic acid) (PLGA).

24. The method of claim 16, wherein the polymer is selected from the group consisting of: polyvinylpyrrolidone or polyacrylamide.
